(19) United States
(12) Patent Application Publication
(10) Pub. No.: US 2026/0016316 A1
(43) Pub. Date: Jan. 15, 2026

(54) UPDATING POSE GRAPHS ASSOCIATED WITH VERSIONED DATA FOR AUTONOMOUS SYSTEMS AND APPLICATIONS

(71) Applicant: NVIDIA Corporation, Santa Clara, CA (US)

(72) Inventor: Chirag Ashokbhai Majithia, Santa Clara, CA (US)

(21) Appl. No.: 18/770,454

(22) Filed: Jul. 11, 2024

(51) Int. Cl. G01C 21/00

(52) U.S. Cl. CPC G01C 21/3867; G01C 21/3826

(57) ABSTRACT

In various examples, updating pose graphs using versioned data for autonomous and/or semi-autonomous systems and applications is described herein. Systems and methods herein may generate and/or update a pose graph (e.g., a pose map) associated with an environment, where the pose graph indicates poses associated with data (e.g., the machines when generating the data) used to generate a map. For instance, amounts of coverage associated with first poses may be determined using both a first version of data associated with the first poses and a second version of data, where an amount of coverage may indicate how well the second version of data represents a same area of the environment as compared to the first version of data. The amounts of coverage may then be used to remove one or more of the first poses that include sufficient coverage from the pose graph.

### BACKGROUND

For an autonomous and/or semi-autonomous machine to safely navigate through an environment, the machine may rely on maps—such as navigational, standard-definition (SD), and/or high-definition (HD) maps—corresponding to the environment in which the machine intends to operate. Due to the detailed, three-dimensional, high precision nature of a map, navigating according to the map has proven effective for safe navigation of environments where map information is available. However, in some circumstances, an environment associated with a map may change, such as by changing locations of roads, lanes, traffic signals, traffic signs, parking spots, construction, static barriers, and/or other objects and/or features associated with an exterior environment, or changing locations of shelves, containers, isles, bins, displays, barriers (e.g., walls, doors, etc.), and/or other objects and/or features associated with an interior environment. In such circumstances, it may be important for the map to be updated in order to reflect the changes to the environment.

However, conventional systems that generate such maps may require data collection machines to navigate through an entirety, a majority, or an unnecessarily large portion of the environment in order to capture enough data to perform batch rebuilds. As such, updating the maps using such a process may require a large amount of planning and/or resources associated with navigating the data collection machines. Additionally, and for similar reasons, conventional systems that generate such maps update an entirety of the maps (e.g., perform batch rebuilds) using large amounts of data. For example, the conventional systems may perform the batch rebuilds using data generated using the data collection machines that have traveled throughout an entirety of the environment. As such, updating the maps using such a process may require large amounts of time, such as weeks and/or months, as well as extensive computing resources. Based on these drawbacks, the maps generated and/or provided by these conventional systems may be outdated, which may cause these maps to be less reliable for performing various operations using machines that rely on the maps.

### SUMMARY

Embodiments of the present disclosure relate to performing incremental map updates and/or updating pose graphs using versioned data for autonomous and/or semi-autonomous systems and applications. Systems and methods described herein may update portions of a map using data (e.g., sensor data, processed data, etc.) that is obtained at various periods of time, where the data may be versioned in order to indicate the newest data for updating different portions of the map. For example, instances of data that are generated at different periods of time may be associated with different versioning information indicating a timing order for which the instances of data were generated with respect to one another. The versioned data may then be used to perform the incremental map updates, such as by updating individual and/or groups of voxels associated with the map. For example, where newer data is available, voxels may be updated using the newer data that more likely represents the current layout of environment as compared to older data that is less likely represents the current layout of environment.

Systems and methods herein may also generate and/or update a pose graph (e.g., a pose map) associated with the environment, where the pose graph indicates poses associated with the data (e.g., poses of the machines when generating the data). For instance, the pose graph may indicate first poses associated with one or more first versions of data used to generate the map. When one or more second versions of data are then generated, one or more second poses associated with the second version(s) of data may then be mapped with respect to the first poses on the pose graph. Additionally, amounts of coverage associated with the first poses may be determined using both the first version(s) of data and second version(s) of data, where an amount of coverage may indicate how well the second version(s) of data represents a same area of the environment as compared to a portion of the first version(s) of data associated with a first pose. As described in more detail herein, the amounts of coverage may then be used to remove one or more of the first poses that include sufficient coverage from the pose graph and/or remove at least a portion of the first version(s) of the data that includes sufficient coverage. This way, the pose graph may indicate the most updated poses associated with the most updated data used to generate the map.

In contrast to conventional systems, the systems of the present disclosure may use the versioned data to perform the incremental updates associated with the map, such as at a voxel level. This way, the systems of the present disclosure do not require data collection machines to generate data representing a majority of the environment to perform updates to the map and/or may not require updating large portions of the map, such as by performing batch updates, as performed by the conventional systems. As described in more detail herein, by including these improvements, the systems of the present disclosure may further require less computing resources when updating the map and/or may keep the map updated such that the map continues to represent a most updated layout of the environment, such as the current locations of the objects and/or features within the environment even when locations of at least a portion of the objects and/or features are recently changed.

Additionally, in contrast to the conventional systems, the systems of the present disclosure may use the pose graph to ensure that the most updated data is used to update the map while, in some circumstances, still considering older data. For instance, in some examples, the most updated data may represent more than the actual objects located within the environment, such as dynamic objects that usually should not be represented by the map. As such, and as described in more detail herein, the systems of the present disclosure may use both the older version(s) of data along with the newer version(s) of data to determine the locations of the static objects within the environment without including the dynamic objects. For example, by using both versions of data, the systems of the present disclosure may be able to determine that it is a dynamic object that is causing a voxel to appear occupied when processing the newer version(s) data by also processing the older version(s) data that represents the same voxel.

### BRIEF DESCRIPTION OF THE DRAWINGS

The present systems and methods for performing incremental map updates and/or updating pose graphs using versioned data for autonomous and/or semi-autonomous systems and applications are described in detail below with reference to the attached drawing figures, wherein:

FIG. 1 illustrates an example data flow diagram for a process of performing incremental map updates using versioned data, in accordance with some embodiments of the present disclosure;

FIG. 2 illustrates an example of a map that indicates an initial layout of an environment, in accordance with some embodiments of the present disclosure;

FIGS. 3A-3B illustrate an example of aligning data with respect to an environment, in accordance with some embodiments of the present disclosure;

FIG. 4 illustrates an example of updating a map to indicate locations of objects located within an environment, in accordance with some embodiments of the present disclosure;

FIG. 5 illustrates an example of a pose graph that is related to a map associated with the environment, in accordance with some embodiments of the present disclosure;

FIG. 6 illustrates an example of aligning new data with respect to old data associated with an environment, in accordance with some embodiments of the present disclosure;

FIGS. 7A-7B illustrate an example of again updating a map to indicate locations of objects located within an environment, in accordance with some embodiments of the present disclosure;

FIG. 8 illustrates an example of updating a pose graph that is related to a map associated with the environment, in accordance with some embodiments of the present disclosure;

FIG. 9 illustrates an example data flow diagram for a process of updating a pose graph using versioned data, in accordance with some embodiments of the present disclosure;

FIGS. 10A-10B illustrate an example of generating a new edge between nodes of a pose graph, in accordance with some embodiments of the present disclosure;

FIGS. 11A-11E illustrate an example of removing one or more old nodes from a pose graph using one or more techniques, in accordance with some embodiments of the present disclosure;

FIGS. 12-13 illustrate flow diagrams showing methods for performing incremental map updates using versioned data, in accordance with some embodiments of the present disclosure;

FIGS. 14-15 illustrate flow diagrams showing methods for updating pose graphs using versioned data, in accordance with some embodiments of the present disclosure;

FIG. 16A is an illustration of an example autonomous vehicle, in accordance with some embodiments of the present disclosure;

FIG. 16B is an example of camera locations and fields of view for the example autonomous vehicle of FIG. 16A, in accordance with some embodiments of the present disclosure;

FIG. 16C is a block diagram of an example system architecture for the example autonomous vehicle of FIG. 16A, in accordance with some embodiments of the present disclosure;

FIG. 16D is a system diagram for communication between cloud-based server(s) and the example autonomous vehicle of FIG. 16A, in accordance with some embodiments of the present disclosure;

FIG. 17 is a block diagram of an example computing device suitable for use in implementing some embodiments of the present disclosure; and

FIG. 18 is a block diagram of an example data center suitable for use in implementing some embodiments of the present disclosure.

### DETAILED DESCRIPTION

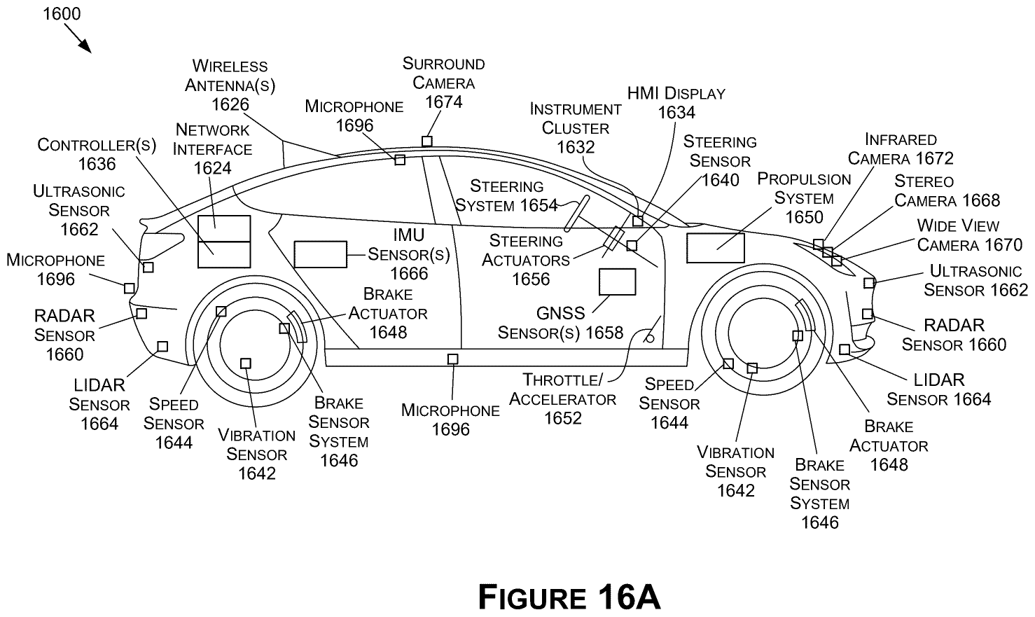

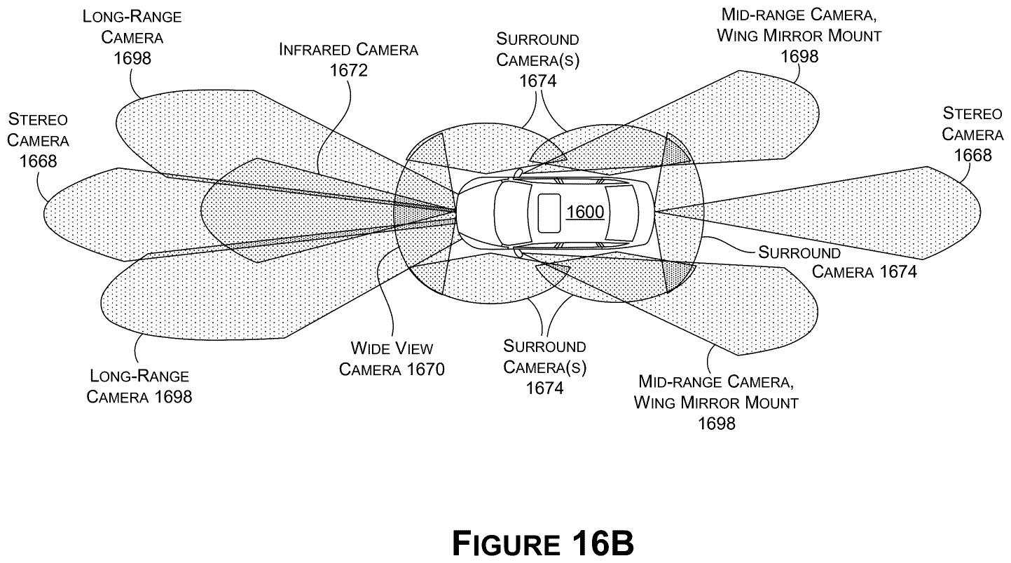

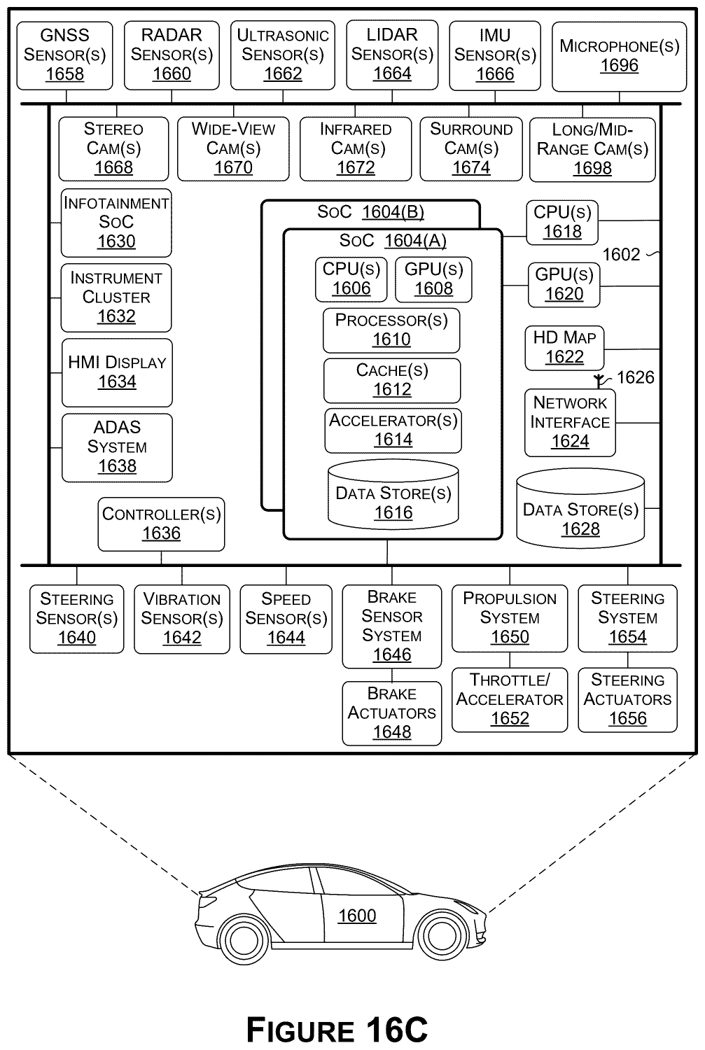

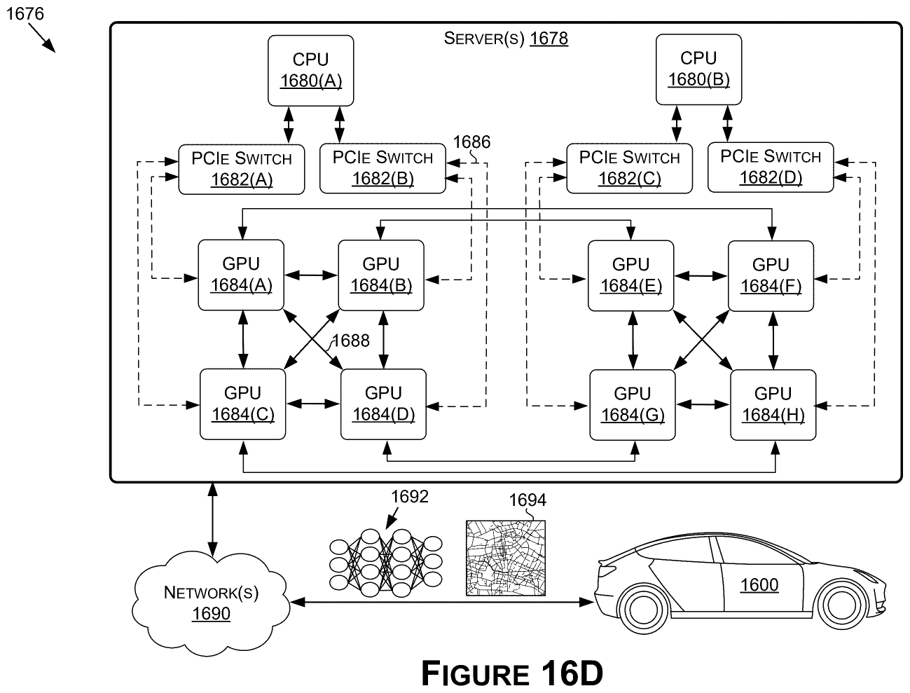

Systems and methods are disclosed related to performing incremental map updates and/or updating pose graphs using versioned data for autonomous and/or semi-autonomous systems and applications. Although the present disclosure may be described with respect to an example autonomous or semi-autonomous vehicle or machine 1600 (alternatively referred to herein as “vehicle 1600,” “ego-vehicle 1600,” “ego-machine 1600,” or “machine 1600,” an example of which is described with respect to FIGS. 16A-16D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to generating and/or updating maps and/or pose graphs associated with environments for autonomous or semi-autonomous systems and applications, this is not intended to be limiting, and the systems and methods described herein may be used in augmented reality, virtual reality, mixed reality, robotics, security and surveillance, autonomous or semi-autonomous machine applications, and/or any other technology spaces where object detection and/or map creation may be used.

For instance, a system(s) may generate a map associated with an environment, such as an exterior environment (e.g., city, state, country, park, etc.), an interior environment (e.g., a warehouse, building, factory, home, etc.), and/or any other type of environment, where the map indicates locations of objects and/or features located within the environment. For instance, and as described herein, a map for an exterior environment may indicate the locations of roads, lanes, traffic signals, traffic signs, parking spots, construction, static barriers, and/or other objects and/or features associated with the exterior environment. Additionally, a map for an interior environment may indicate the locations of shelves, containers, isles, bins, displays, barriers (e.g., walls, doors, etc.), tables, chairs, and/or other objects and/or features associated with the interior environment. To update the map, the system(s) may receive data from one or more data collection machines. In some examples, the data may include sensor data generated using one or more sensors (e.g., image sensors, LiDAR sensors, RADAR sensors, ultrasonic sensors, etc.), processed data from one or more systems (e.g., perception outputs indicating locations of objects and/or features), location data indicating locations of the machine(s) when generating the data, and/or any other type of data that may be generated using the machine(s).

The system(s) may then localize the machine(s) and/or the data with respect to the environment, such as by using at least a portion of the data (e.g., the location data, etc.). For example, if the system(s) receives data from two machines that perform two drives within the environment, the system(s) may determine first poses associated with a first drive (e.g., first tracks) of a first machine when generating first data and second poses associated with a second drive (e.g., second tracks) of a second machine when generating second data. The system(s) may then determine first reference coordinates associated with the first poses within the environment using a first reference coordinate system associated with one of the first poses and second reference coordinates associated with the second poses within the environment using a second reference coordinate system associated with one of the second poses. Additionally, in some examples, the system(s) may then relate the first poses with respect to the second poses, such as by using common reference coordinates associated with a common reference system from one of the first poses or the second poses.

The system(s) may then use the data to update the map in order to indicate the locations of objects and/or features located within the environment. As described herein, in some examples, the system(s) may use any technique to update the map using the data. For example, such as when the data includes sensor data, the system(s) may project points using the data in order to determine whether portions of the environment are in an occupied state, an unoccupied state, an unknown state, and/or any other state. As described herein, the portions of the environment may represent any two-dimensional (2D) and/or three-dimensional (3D) areas of the environment, such as voxels (and/or any other 3D shapes) associated with the environment. Additionally, in some examples, the system(s) may determine that a portion is in the occupied state when a point associated with a ray is located within the portion, an unoccupied state when a ray passes through the portion, or an unknown state when a ray does not contact (e.g., does not stop within and/or pass through) the portion (e.g., there is no data associated with the portion).

The system(s) may also use one or more techniques to determine one or more versions associated with this initial data. For instance, in some examples, data that is generated between events may be associated with a same version indicating that the data represents a same layout of the environment (e.g., it is unlikely updates have been performed to the layout of the environment). As described herein, an event may include, but is not limited to, a period of time elapsing (e.g., one hour, one day, one week, one month, etc.), one or more updates occurring with respect to the environment (e.g., an object and/or feature being added, removed, and/or moved), and/or any other event. For example, and using the example above wherein the data is associated with the two drives, the system(s) may determine a first version associated with the first data, such as version 1.01 (and/or any other version), and determine a second version associated with the second data, such as version 1.02 (and/or any other version), where both versions are still associated with a same total version, such as version 1. As described in more detail herein, in some examples, the version(s) associated with the initial data (e.g., version 1) may be used to determine the age of the data when performing one or more additional updates associated with the map.

The system(s) may also generate and/or update a pose graph associated with data that is used to generate and/or update the map. As described herein, the pose graph may include at least nodes indicating poses associated with instances of data used to update the map and/or edges that associate with the nodes with one another (e.g., associate transformations between the nodes). For example, and using the example above, the system(s) may initially generate the pose graph to include first nodes indicating the first poses associated with the first data generated using the first machine and second nodes indicating the second poses associated with the second data generated using the second machine. Additionally, the pose graph may include edges that connect at least a portion of the first poses together, connect at least a portion of the second poses together, and/or connect at least a portion of the first poses with at least a portion of the second poses together. In some examples, the system(s) may use one or more techniques to generate the edges between the nodes.

For example, to determine whether a new edge should be generated between two nodes, the system(s) may determine a first distance (e.g., a graph distance) indicating a number of edges between the nodes and a second distance (e.g., a physical distance) indicating an actual distance between the nodes within the environment (e.g., based at least on the coordinates of the nodes within the environment). The system(s) may then use the first distance and the second distance to determine whether to generate the new edge between the nodes. For example, the system(s) may divide the first distance by the second distance and then use that solution to determine whether to generate the edge, such as by using one or more thresholds. In some examples, the system(s) may perform such processes since new edges may be needed between nodes for which there is a small physical distance within the environment, but a large number of edges between the nodes. In such examples, this may be to help reduce the number of transformations needed when performing one or more of the processes described herein with respect to the pose graph, such as when updating the map using the data associated with the nodes from the pose graph.

When determining to add a new edge between nodes, the system(s) may use one or more additional criteria. For instance, in some examples, the system(s) may use descriptors associated with the nodes to verify that the nodes are associated with a similar space, such as a same environment, a same portion (e.g., room, etc.) within the environment, and/or so forth. For a first example, if two descriptors for two nodes indicate that the two nodes are within a similar space, such as a room of the environment, then the system(s) may still determine to add the edge between the nodes (e.g., using one or more of the techniques described herein). However, if the descriptors for the two nodes indicate that the nodes are not within a similar space, such as different rooms of the environment, then the system(s) may determine not to add the edge between the nodes.

The system(s) may generate and/or store data associated with the map. As described herein, in some examples, the system(s) may store data associated with the portions of the map that are in the occupied state. For example, the system(s) may store data indicating locations (e.g., the x-coordinate locations, the y-coordinate locations, and/or the z-coordinate locations) of the portions, dimensions of the portions (e.g., dimensions of the voxels), and/or identifiers of the portions that are in the occupied state. However, in other examples, the system(s) may further store similar data associated with other portions, such as portions that are in one or more other states like the unoccupied state and/or the unknown state. Additionally, in some examples, the system(s) may store data representing semantic information associated with the portions of the map. For example, the system(s) may store data indicating object classifications associated with the portions, such as whether the portions are associated with a ground and/or other type of object.

Additionally, in some examples, the system(s) may cause the pose graph to be in a “fixed” state such that the locations of the nodes cannot be updated. However, since some errors may occur when generating the pose graph, the system(s) may later cause the pose graph to switch from a fixed state to an “unfixed” state. In the unfixed state, updates may occur with regard to the pose graph, such as by updating one or more locations of one or more nodes, removing one or more nodes, adding one or more nodes, adding one or more edges (described in more detail herein), adding one or more semantic labels, and/or performing any other type of update. As described herein, in some examples, an update may occur based at least on user input, such as user input indicating an updated location associated with a node within the environment. Additionally, or alternatively, in some examples, an update may occur based at least on further processing the data (and/or new data, which is described below) using one or more of the processes described herein. Once the pose graph is updated, the system(s) may then cause the pose graph to switch from the unfixed state to the fixed state such that the locations of nodes again cannot be updated.

Furthermore, in some examples, the system(s) may “lock” the pose graph such that the locations of the current nodes cannot be updated (and/or switched to the unfixed state), such as during further updates to the pose graph using new data. For instance, since the updates to the map are finished at this point, the pose graph may include a “base” pose graph associated with the map. As such, and as described in more detail herein, when the map is later updated again, such that the map includes an older version of the map before the updates, the nodes of this base pose graph associated with this older version of the map should not be updated to ensure that the nodes remain accurate with respect to the map. Rather, new nodes associated with new data received to update the map may be used to add new nodes to the pose graph.

As described herein, the system(s) may then receive additional data (e.g., additional sensor data, etc.) from one or more data collection machines navigating within the environment and use the additional data to update the map associated with the environment. For instance, the system(s) may receive new data generated using a machine navigating within a region of the environment. In some examples, since the new data is received after an event occurs with respect to the initial data (e.g., the first and/or second data above), such as after the period of time elapses and/or the environment is updated, the system(s) may associate the new data with a new version, such as version 2 (and/or any other version in these examples). This way, the system(s) may be able to determine that the new data was generated after the initial data. As described herein, newer data may better represent the current layout of the environment, such as any updates to the environment that have occurred after a previous update associated with the map.

The system(s) may then align the new data with respect to the initial data, such as by aligning new poses associated with the new data with respect to the initial poses associated with the initial data. As described in more detail herein, in some examples, the system(s) may align the new data using any technique, such as by localizing the new data using sensor data and/or location data from the new data. The system(s) may then use the new data to update at least a portion of the map that corresponds to the portion of the environment for which the new data represents. For instance, in some examples, the system(s) may project rays using the new data in order to determine whether portions of the environment are in the occupied state, the unoccupied state, the unknown state, and/or any other state. The system(s) may then generate a new map that indicates at least the states associated with the portions of the environment determined using this new data. Additionally, the system(s) may update the map by merging the map with this updated map, such as by updating one or more portions of the map using the updated map.

For a first example, if the map (and/or the initial data) indicates that a portion (e.g., a voxel) of the environment includes an occupied state, then the system(s) may confirm that the portion is in the occupied state when the updated map indicates that the portion is also in the occupied state (e.g., a point associated with a ray is located within the portion) or update the portion to an unoccupied state when the updated map indicates that the portion is in the unoccupied state (e.g., a ray passes through the portion). For a second example, if the map (and/or the initial data) indicates that a portion (e.g., a voxel) of the environment includes an unoccupied state, then the system(s) may confirm that the portion is in the unoccupied state when the updated map indicates that the portion is also in the unoccupied state (e.g., a ray passes through the portion) or update the portion to an occupied state when the updated map indicates that the portion is in the occupied state (e.g., a point associated with a ray is located within the portion).

For a third example, if the map (and/or the initial data) indicates that a portion (e.g., a voxel) of the environment includes an unknown state, then the system(s) may confirm that the portion is in the unknown state when the updated map indicates that the portion is also in the unknown state (e.g., the new data does not represent the portion such that a ray does not contact the portion), update the portion to an occupied state when the updated map indicates that the portion is in the occupied state (e.g., a point associated with a ray is located within the portion), or update the portion to an unoccupied state when the updated map indicates that the portion is in the unoccupied state (e.g., a ray passes through the portion). Still, for a fourth example, if the map (and/or the initial data) indicates that a portion (e.g., a voxel) of the environment includes any state, then the system(s) may maintain the state of the portion if the updated map indicates that the portion is in an unknown state (e.g., the new data does not represent the portion such that a ray does not contact the portion). While these are just a few example techniques of how the system(s) may update the map using the updated map, in some examples, the system(s) may use additional and/or alternative techniques to update the map.

In some examples, the system(s) may also update the base pose graph using the new data. For instance, the system(s) may generate a new pose graph that includes one or more new nodes indicating one or more new poses associated with the new data that was used to generate the new map (e.g., the map that is used to update the previous version of the map, as described herein). The system(s) may then use one or more techniques in order to remove one or more initial nodes indicating one or more initial poses associated with the initial data, where the initial nodes are associated with the base pose graph associated with the previous version of the map before the updates and/or stored in one or more databases. For instance, and for an initial node, the system(s) may identify one or more new nodes from the new pose graph that are related to the initial node. In some examples, a new node may be related to the initial node based at least on a pose associated with the new node being within a threshold distance to a pose associated with the new node. The system(s) may then use at least a portion of the initial data that is associated with the initial node and at least a portion of the new data that is associated with the new node(s) to determine an amount of coverage associated with the initial node. In some examples, the amount of coverage may be associated with understanding new information in new data (as compared to the old data) that is useful for mapping.

For instance, the system(s) may project points within the environment using the at least the portion of the initial data. The system(s) may then determine portions of the environment that are associated with the points, such as voxels that surround the points. Additionally, the system(s) may project rays into the environment using the at least the portion of the new data and use the rays to determine a number of the portions of the environment that are contacted by the rays. The system(s) may then determine the amount of coverage using the number of contacted portions and a total number of portions. For example, the system(s) may determine the amount of coverage as a percentage by dividing the number of contacted portions by the total number of portions. By performing such processes, the amount of coverage may indicate differences between the old data and the new data, which is aligned together. For instance, the amount of coverage may indicate what information has changed between the old data and the new data, such as which voxels were added, which voxels were removed, and which voxels contain no new information (e.g., the voxels are obstructed).

Additionally, the system(s) may remove the initial node from the base pose graph (and/or the database) when the amount of coverage satisfies (e.g., is equal to or greater than) a threshold percentage (e.g., 80%, 85%, 90%, 95%, etc.) or refrain from removing the initial node from the base pose graph (and/or the database) when the amount of coverage does not satisfy (e.g., is less than) the threshold percentage. Additionally, the system(s) may perform similar processes for one or more (e.g., each) of the initial nodes associated with the base pose graph.

In some examples, the system(s) may perform these processes of removing one or more initial nodes from the pose graph (and/or the database) since the system(s) determines that the initial node(s) includes a redundant node(s). This is because the new data that was used to update the map covers the same portion of the environment that the old data associated with the redundant node(s) also covered within the environment. As such, the system(s) may remove the initial node(s) and/or the old data (e.g., one or more previous versions of the data that are covered) associated with the initial node(s) such that the system(s) will not again process the old data when performing additional updates to the map. Rather, the system(s) will use the new data that better represents that portion of the environment, such as any updates that occurred to that portion of the environment. This way, the system(s) may reduce the amount of data that is processed when updating the map while still ensuring that any updates to the map correctly represent the current environment. Additionally, the system(s) may save computing resources, such as storage, since the old data associated with the removed nodes may be removed from memory.

In some examples, the system(s) may then continue to perform these processes in order to continue receiving new data from one or more data collection machines located within the environment and updating the map and/or the pose graph using the new data. As such, by continuing to perform these processes, the system(s) may ensure that the map remains updated such that the map represents a current layout of the environment. Additionally, by updating the pose graph, the system(s) may ensure that the map is updated using the newest data that best represents the current layout of the environment.

In some examples, the system(s) may then perform one or more processes using the map associated with the environment. For instance, the system(s) may send data representing the map to one or more machines navigating within the environment, where the machine(s) may use the map when navigating. For instance, a machine may use the map to determine locations of objects and/or features located within the environment and then use these locations to determine how to navigate within the environment. In some examples, while navigating, these machines may also send new data to the system(s) such that the system(s) is able to continue updating the map and/or the pose graph.

In some embodiments, the systems and methods described herein may be performed within a simulation environment (e.g., NVIDIA's DriveSIM) using simulated data (e.g., simulated sensor data of simulated sensors of a virtual or simulated machine). For example, simulated sensor data and/or simulation data representing the simulated environment may be used to generate and/or update map data. In some examples, the simulation may correspond to a digital twin of the region being mapped, and the map may correspond to the real-world environment of the digital twin and/or may be a map of the digital twin environment. In some embodiments, the simulated environment and/or data may be used to test performance of the underlying algorithms (e.g., map update algorithms), and/or may be used to update the digital twin over time (e.g., in real-time) as changes are made to the environment being simulated/replicated. As such, information from the generated digital twin (which may be generated/updated/rendered based on the map data updated from the real-world environment) may be used for testing, evaluation, deployment (e.g., to provide feedback, control, planning, etc. commands to a real-world machine), and/or other use cases. In some embodiments, the generated maps may be used to update the digital twin such that testing of the underlying systems (e.g., a virtual machine corresponding to the real-world machine) may be performed within a simulated digital twin prior to deploying the real-world machine within the environment. In some instances, the simulation may be used to generate synthetic training data, and the synthetic training data may then be processed to test algorithms (e.g., neural networks, machine learning models, computer vision algorithms, planning algorithms, control algorithms, etc.). In any example, such as where a simulation environment (e.g., a digital twin, a synthetic training environment, etc.) is used for testing, validation, training, deployment, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, the map data may be used by one or more teleoperators using a remote control (e.g., teleoperation) system. For example, when making planning, control, actuation, and/or other decisions using the remote control system—the data pertaining to which may be sent to the vehicle, machine, robot, etc. being remotely controlled—the remote operator may use the map data to help make these decisions. For example, the map may inform the remote operator of a location for a robot to navigate to within an environment, and the remote operator may control (e.g., using remote control devices) the robot within the environment, or the remote operator may send indications of where the robot is to navigate, and the robot may receive this information and update its internal planning to follow the proposed path (so long as the path is determined to be safe).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

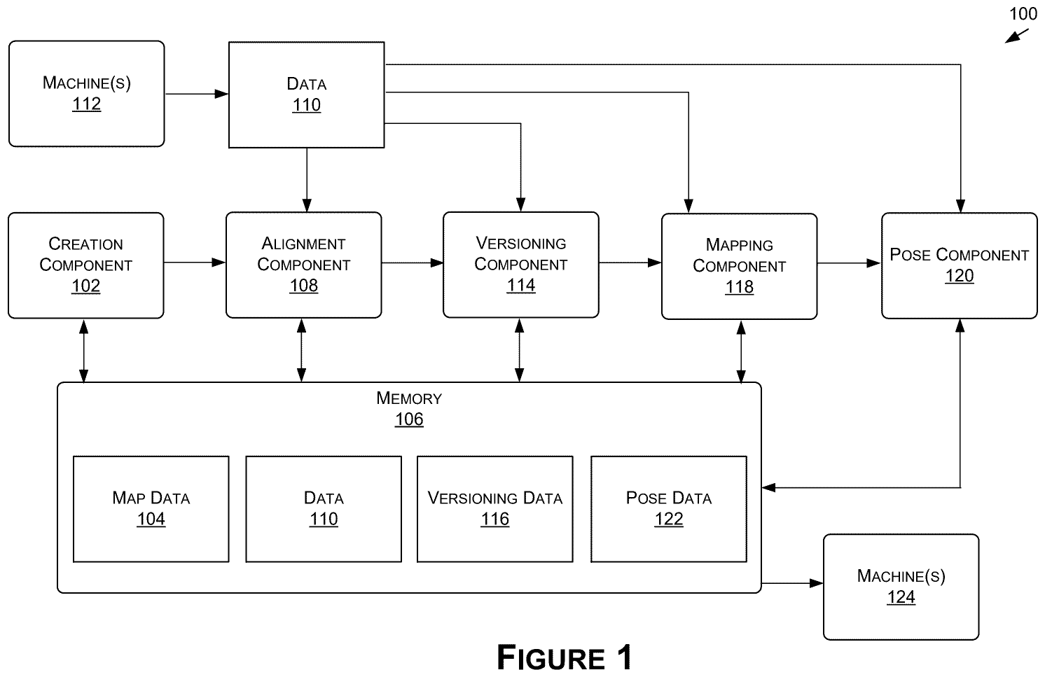

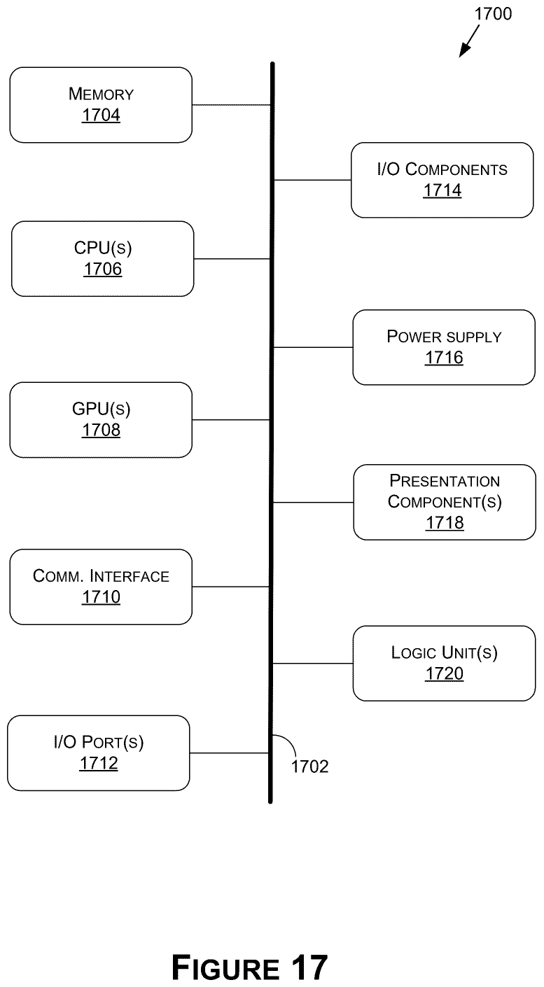

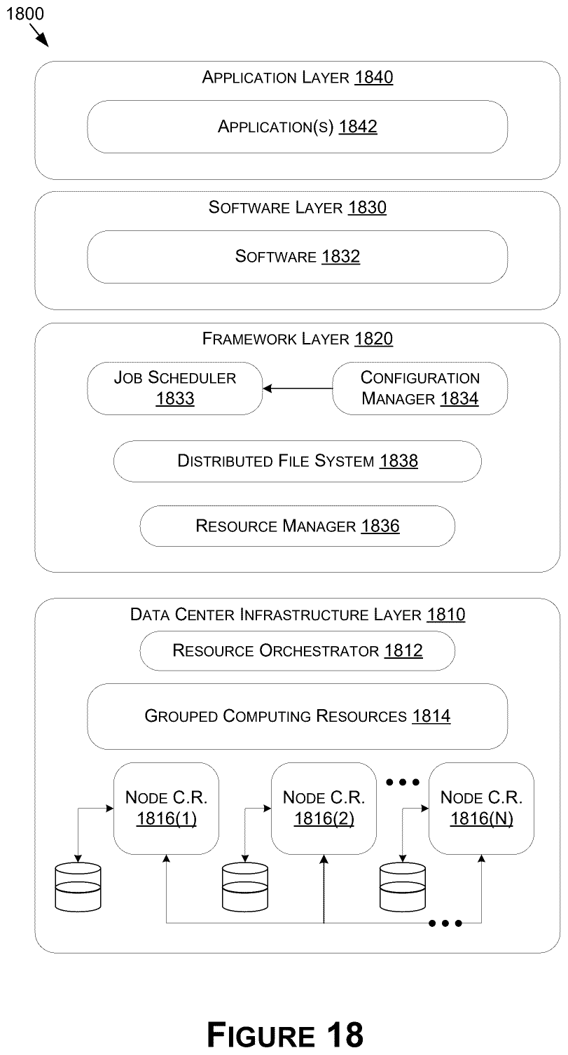

With reference to FIG. 1, FIG. 1 illustrates an example data flow diagram for a process 100 of performing incremental map updates using versioned data, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1600 of FIGS. 16A-16D, example computing device 1700 of FIG. 17, and/or example data center 1800 of FIG. 18.

The process 100 may include a creation component 102 generating a map (e.g., an HD map 1622) associated with an environment, where the map may be represented by map data 104 stored in memory 106. As described herein, the map generated by the creation component 102 may represent the layout of the environment. However, and using one or more of the techniques described herein, the map may then be updated to indicate locations of objects and/or features located within the environment, classifications associated with objects and/or features located within the environment, and/or any other information associated with the environment. For a first example, if the map is associated with an exterior environment, then the map may indicate the locations of roads, lanes, traffic signals, traffic signs, parking spots, construction, static barriers, and/or other objects and/or features associated with the exterior environment. For a second example, if the map is associated with an interior environment, then the map may indicate the locations of shelves, containers, isles, bins, displays, barriers (e.g., walls, doors, etc.), tables, chairs, and/or other objects and/or features associated with the interior environment. While these are just a few examples of maps that may be generated by the creation component 102, in other examples, the creation component 102 may generate any other type of map.

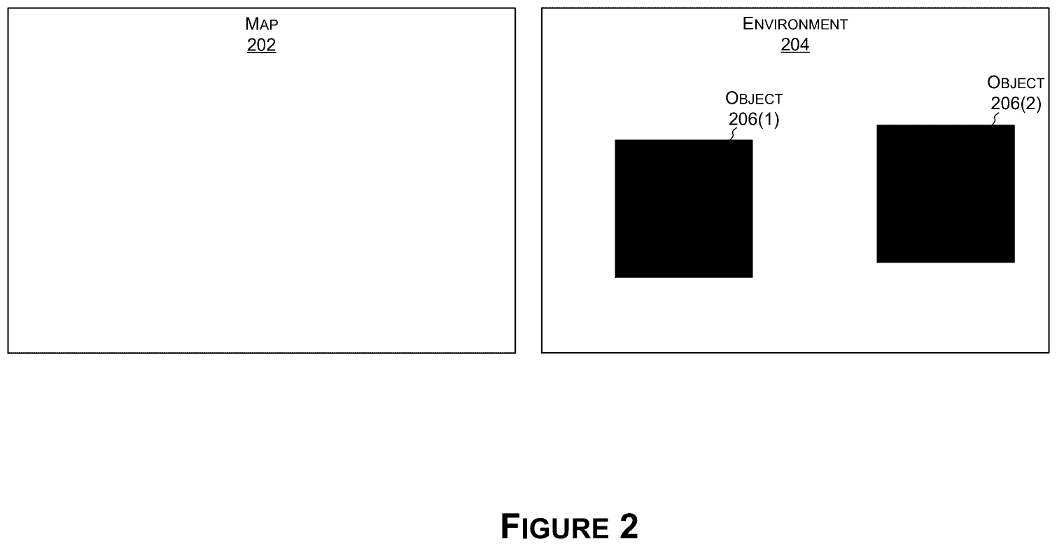

For instance, FIG. 2 illustrates an example of a map 202 that indicates an initial layout of an environment 204, in accordance with some embodiments of the present disclosure. In the example of FIG. 2, the creation component 102 may generate the map 202 representing the environment 204 that includes a simple structure, such as a rectangular structure where the sides of the map represent the outer walls of the environment 204. However, in other examples, the environment 204 associated with the map 202 may include any other type of structure and/or may include an exterior environment. Additionally, in some examples, the creation component 102 may generate the map 202 using any type of data, such as sensor data, processed data, data representing a layout of the environment 204, and/or so forth. As further shown, an initial layout for the environment 204 may include two objects 206(1)-(2) (also referred to singularly as “object 206” or in plural as “objects 206”) located within the environment 204. However, in other examples, the environment 204 may include any number of objects located at any location within the environment 204.

Referring back to the example of FIG. 1, the process 100 may include an alignment component 108 receiving data 110 generated using one or more machines 112 navigating within the environment. As described herein, the data 110 may include, but is not limited to, sensor data generated using one or more sensors (e.g., one or more image sensors, one or more LiDAR sensors, one or more RADAR sensors, one or more ultrasonic sensors, etc.) of the machine(s) 112, processed data from one or more systems of the machine(s) 112, location data indicating locations of the machine(s) 112, and/or any other type of data that may be generated using the machine(s) 112. Additionally, processed data may include one or more outputs from the system(s) of the machine(s) 112, such as outputs indicating locations of objects and/or features from one or more perception systems of the machine(s) 112. Furthermore, location data may represent 2D locations, 3D locations, relative locations, motion information, and/or any other type of location information associated with the machine(s) 112.

The alignment component 108 may then be configured to align the data 110 with respect to the environment using one or more techniques, such as one or more localization techniques. For example, if the data 110 includes first data 110 generated during one or more first drives of one or more first machines 112 and second data 110 generated during one or more second drives of one or more second machines 112, then the alignment component 108 may determine first poses associated with the first drive(s) (e.g., first tracks) and second poses associated with the second drive(s) (e.g., second tracks) within the environment. Additionally, the alignment component 108 may determine first reference coordinates associated with the first poses within the environment using a first reference coordinate system associated with one of the first poses and second reference coordinates associated with the second poses within the environment using a second reference coordinate system associated with one of the second poses. In some examples, the alignment component 108 may then relate the first poses with respect to the second poses, such as by using common reference coordinates associated with a common reference system from one of the first points or the second points.

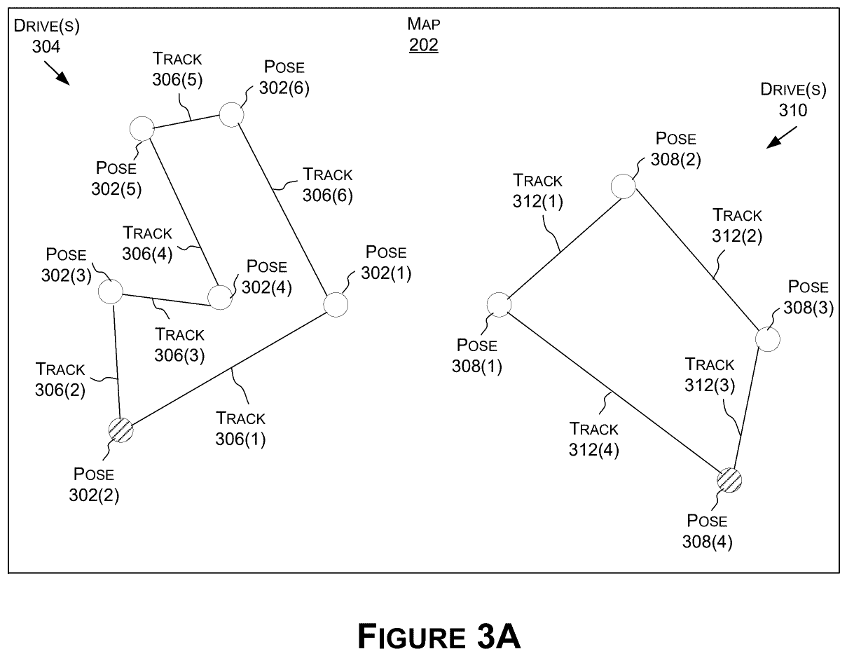

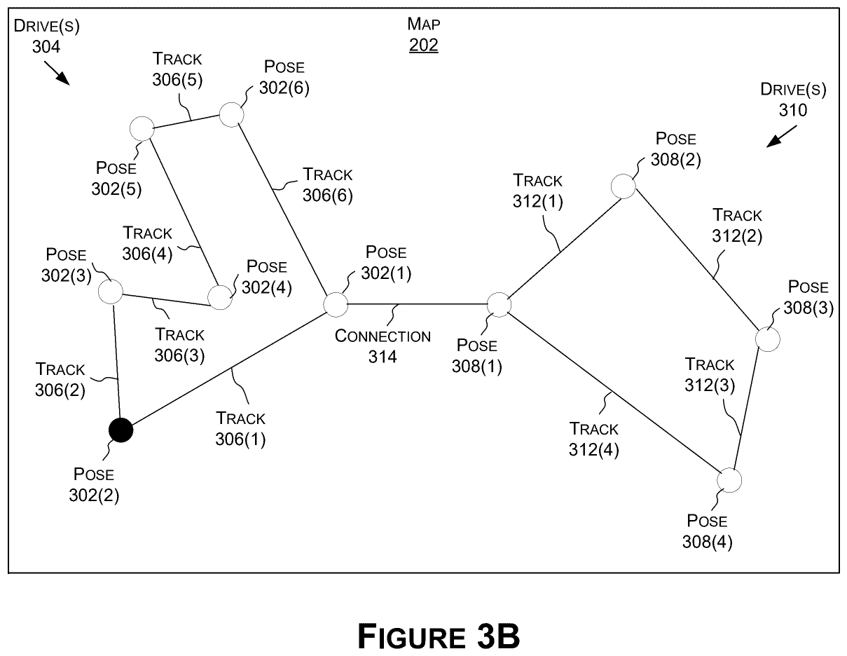

For instance, FIGS. 3A-3B illustrate an example of aligning data with respect to the environment 204, in accordance with some embodiments of the present disclosure. As illustrated by the example of FIG. 3A, the alignment component 108 may determine first poses 302(1)-(6) (also referred to singularly as “pose 302” or in plural as “poses 302”) associated with one or more first drives 304 by one or more first machines, where the first drive(s) 304 is associated with first tracks 306(1)-(6), and second poses 308(1)-(4) (also referred to singularly as “pose 308” or in plural as “poses 308”) associated with one or more second drives 310 by one or more second machines, where the second drive(s) 310 is associated with second tracks 312(1)-(4). In some examples, the alignment component 108 may then determine a first reference point associated with a first coordinate system for the poses 302, which is indicated by the pose 302(2) including a pattern, and a second reference point associated with a second coordinate system for the poses 308, which is indicated by the pose 308(4) including a pattern. This way, the alignment component 108 may determine relative locations of the poses 302 within the environment using the first coordinate system and relative locations of the poses 308 within the environment using the second coordinate system.

Next, and as illustrated by the example of FIG. 3B, the alignment component 108 may align the poses 302 with respect to the poses 308 using a connection 314 (e.g., a loop) that connects at least one of the poses 302 with at least one of the poses 308. Additionally, the alignment component 108 may determine a final reference point associated with a final coordinate system for the environment, which is indicated by the pose 302(2) including the solid color. This way, the alignment component 108 may determine relative locations of the poses 302 and the poses 308 within the environment using the same coordinate system.

Referring back to the example of FIG. 1, the process 100 may include a versioning component 114 determining one or more versions associated with the data 110, where versions associated with data 110 may be represented by versioning data 116. As described herein, in some examples, data 110 that is generated between events may be associated with a same version indicating that the data 110 likely represents a same layout of the environment (e.g., it is unlikely updates have been performed to the layout of the environment). In some examples, an event may include, but is not limited to, a period of time elapsing (e.g., one hour, one day, one week, one month, etc.), one or more updates occurring with respect to the environment (e.g., an object and/or feature being added, removed, and/or moved), and/or any other event. For example, and referring again to the example of FIGS. 3A-3B, the versioning component 114 may determine a first version associated with the data 110 generated during the first drive(s) 304, such as version 1.01 (and/or any other version), and a related, second version associated with the data 110 generated during the second drive(s) 310, such as version 1.02 (and/or any other version), where both versions are still associated with a same total version, such as version 1.

Referring back to the example of FIG. 1, the process 100 may include a mapping component 118 using the data 110 to update the map, such as to indicate the locations of objects and/or features located within the environment. As described herein, in some examples, the mapping component 118 may use any technique to update the map using the data 110. For example, such as when the data 110 includes sensor data, the mapping component 118 may project points using the data 110 in order to determine whether portions of the environment are in an occupied state, an unoccupied state, an unknown state, and/or any other state. As described herein, the portions of the environment may represent any 2D and/or 3D areas of the environment, such as voxels (and/or any other 3D shapes) associated with the environment. Additionally, in some examples, the mapping component 118 may determine that a portion is occupied when a point associated with a ray is located within the portion, unoccupied when a ray passes through the portion, or unknown when a ray does not contact (e.g., does not stop within and/or pass through) the portion.

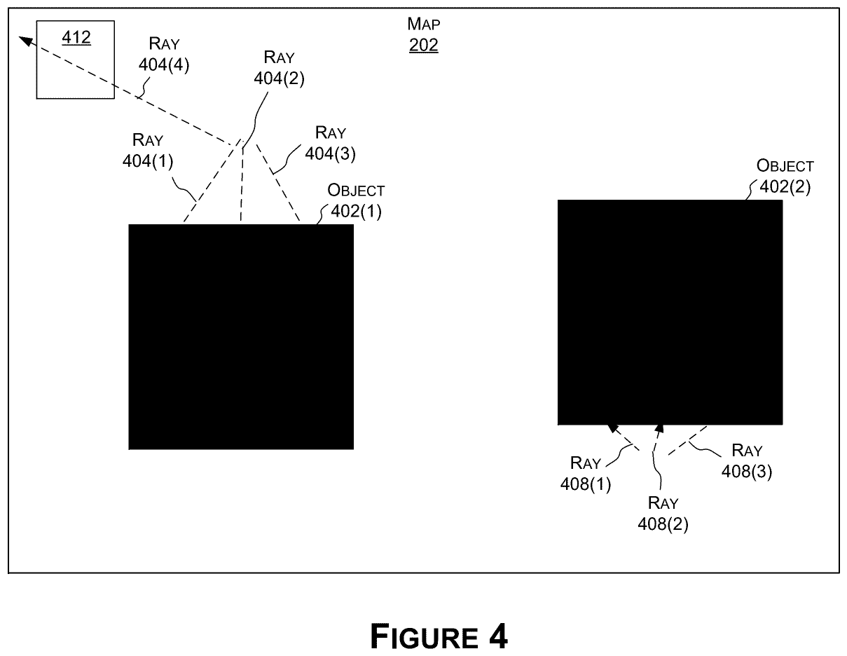

For instance, FIG. 4 illustrates an example of updating the map 202 to indicate locations of the objects 206 located within the environment 204, in accordance with some embodiments of the present disclosure. As shown, the mapping component 118 may determine that a first object 402(1) (which may correspond to the object 206(1)) is located at a first location within the environment 204 using data associated with the first drive(s) 304. In some examples, to make the determination, the mapping component 118 may use the data to project rays 404(1)-(4) (although only a few are illustrated for clarity reasons) associated with the environment 204. The mapping component 118 may then determine that portions 406(1)-(8) of the environment 204 are in the occupied state based at least on points associated with the rays 404(1)-(4) being located within the portions 406(1)-(8) (as indicated by the arrows stopping within at least the portions 406(1)-(3)). As described herein, in some examples, the portions 406(1)-(8) may include voxels located within the environment 204. The mapping component 118 may then update the map 202 to indicate the location of the first object 402(1). For example, and as described in more detail herein, the mapping component 118 may store at least data associated with the portions 406(1)-(8) that are in the occupied state.

Additionally, the mapping component 118 may determine that a second object 402(2) (which may correspond to the object 206(2)) is located at a second location within the environment 204 using data associated with the second drive(s) 310. In some examples, to make the determination, the mapping component 118 may use the data to project rays 408(1)-(3) (although only a few are labeled for clarity reasons) associated with the environment 204. The mapping component 118 may then determine that portions 406(9)-(16) of the environment are in the occupied state based at least on points associated with the rays 408(1)-(3) being located within the portions 404(9)-(16) (as indicated by the arrows stopping within at least the portions 404(14)-(16)). As described herein, in some examples, the portions 406(9)-(16) may also include voxels located within the environment 204. The mapping component 118 may then update the map 202 to indicate the location of the second object 402(2). For example, and as described in more detail herein, the mapping component 118 may store at least data associated with the portions 406(9)-(16) that are in the occupied state.

As further illustrated by the example of FIG. 4, the mapping component 118 may further determine that portions 410(1)-(2) of the environment are in the unknown state since rays 404(1)-(4) and 408(1)-(3) associated with the data did not pass through and/or contact the portions 410(1)-(2). In some examples, the rays 404(1)-(4) and 408(1)-(3) may not have passed through and/or contacted the portions 410(1)-(2) since they are blocked by the outer surfaces of the objects 402(1)-(2). Additionally, the mapping component 118 may determine that a portion 412 of the environment is in the unoccupied state since one or more rays (e.g., the ray 404(4)) associated with the data passed through the portion 412. While the example of FIG. 4 only illustrates one portion 412 of the environment as being in the unoccupied state for clarity reasons, in other examples, the mapping component 118 may use similar processes to determine that additional portions of the environment are in the unoccupied state. Additionally, as described herein, in some examples, the portions 410(1)-(2) and 412 may also include voxels located within the environment.

While the example of FIG. 4 is illustrating the map 202 using two dimensions, in other examples, similar processes may be used for any other type of map, such as a 3D map. For example, the portions 406(1)-(16), 410(1)-(2), and 412 may include 3D portions of the environment 204 that are associated with at least x-coordinate locations, y-coordinate locations, and z-coordinate locations.

Referring back to the example of FIG. 1, the process 100 may include a pose component 120 generating and/or updating a pose graph associated with data 110 that is used to generate and/or update the map, where the pose graph may be represented by pose data 122. As described herein, the pose graph may include at least nodes indicating poses associated with instances of data used to update the map and/or edges that associate the nodes with one another (e.g., associate transformations between the nodes). As will be described in more detail herein, the pose component 120 may use one or more processes to generate the edges between the nodes included in the pose graph. Additionally, in some examples, the pose component 120 may use one or more processes to update the pose graph, such as by removing one or more older poses, when new data 110 is received.

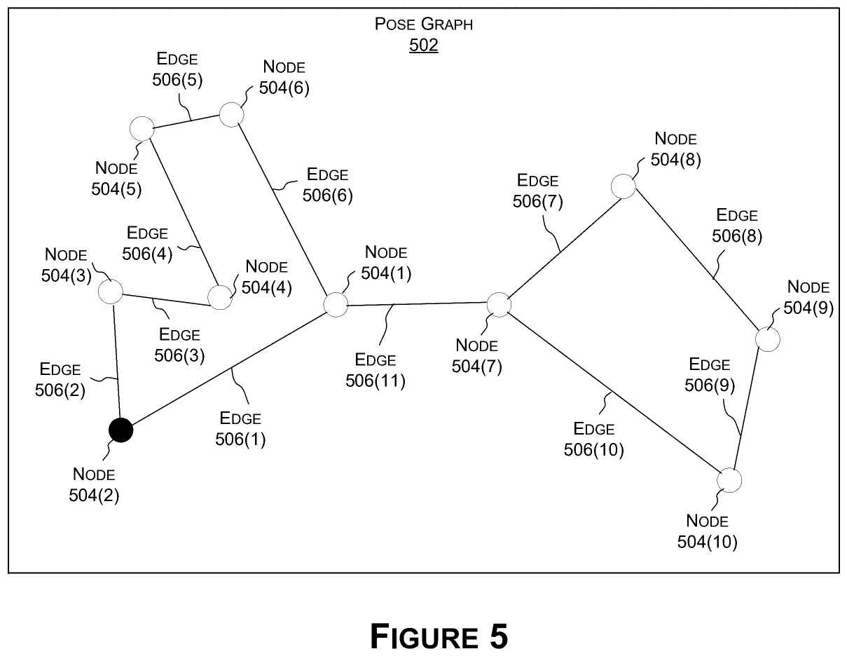

For instance, FIG. 5 illustrates an example of a pose graph 502 that is related to the map 202 associated with the environment 204, in accordance with some embodiments of the present disclosure. As shown, the pose component 120 may initially generate the pose graph 502 to include nodes 504(1)-(10) (also referred to singularly as “node 504” or in plural as “nodes 504”), where the nodes 504 are connected together using edges 506(1)-(11) (also referred to singularly as “edge 506” or in plural as “edges 506”). In some examples, the nodes 504(1)-(6) may respectively indicate the poses 302(1)-(6), the edges 506(1)-(6) may respectively indicate the tracks 306(1)-(6), the nodes 504(7)-(10) may respectively indicate the poses 308(1)-(4), the edges 506(7)-(10) may respectively indicate the tracks 312(1)-(4), and the edge 506(11) may indicate the connection 314. Additionally, in some examples, the pose graph 502 may further be associated with a reference coordinate point, such as the node 504(2), that a reference coordinate system is based on, such as when performing transformations between the nodes 504.

Referring back to the example of FIG. 1, at least a portion of the process 100 may then continue to repeat in order to update the map and/or the pose graph. For instance, the alignment component 108 may receive new data 110 generated using one or more machines 112 navigating within the environment. The process 100 may then include the alignment component 108 aligning the new data 110 with respect to the old data 110, such as by aligning new poses associated with the new data 110 with respect to the old poses associated with the old data 110. As described herein, in some examples, the alignment component 108 may align the new data 110 by localizing the new data 110 (e.g., the machine 112 that generated the new data 110) with respect to the environment and/or the old data 110. Additionally, in some examples, the alignment component 108 may align the new data 110 with the old data 110 by adding one or more connections between one or more of the new poses and one or more of the old poses.

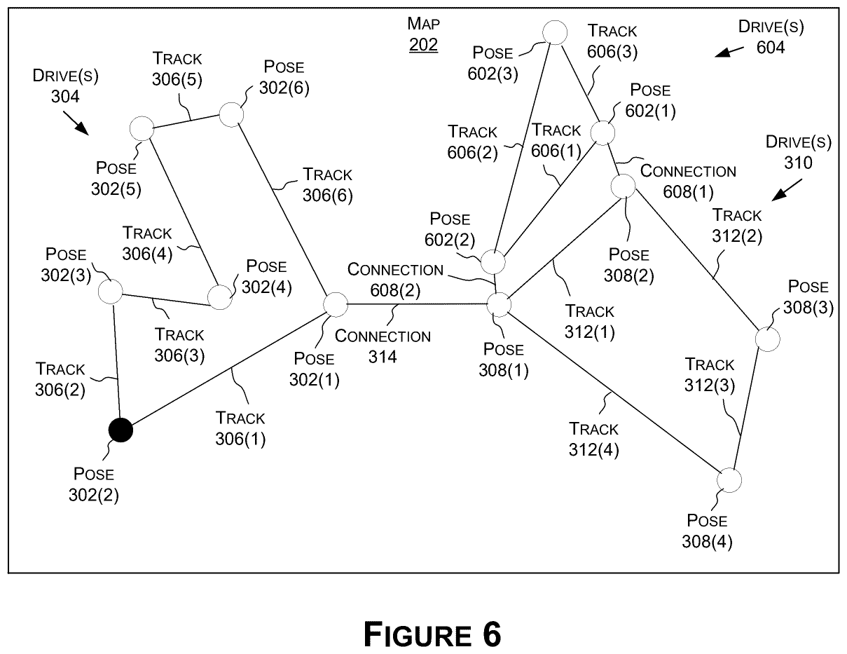

For instance, FIG. 6 illustrates an example of aligning new data with respect to old data associated with the environment 204, in accordance with some embodiments of the present disclosure. As shown, based at least on receiving new data, the alignment component 108 may determine third poses 602(1)-(3) (also referred to singularly as “pose 602” or in plural as “poses 602”) associated with one or more third drives 604 performed by one or more third machines, where the third drive(s) 604 is associated with third tracks 606(1)-(3). As described herein, in some examples, the alignment component 108 may use any technique to align the poses 602, such as by using location data representing locations of the third machine(s) within the environment when generating the new data and/or aligning the poses 602 with respect to the poses 302 and/or the poses 308. For example, the alignment component 108 may perform the alignment by aligning the data associated with the poses 602 with the data associated with the poses 302 and/or the poses 308.

Next, and as further illustrated by the example of FIG. 6, the alignment component 108 may align the poses 602 with respect to at least the poses 308 using a first connection 608(1) (e.g., a first loop) that connects at least the pose 602(1) to the pose 308(2) and/or a second connection 608(2) (e.g., a second loop) that connects at least the pose 602(2) with the pose 308(1). Additionally, the alignment component 108 may determine a final reference point associated with a final coordinate system for the environment, which is still indicated by the pose 302(2) including the solid color. This way, the alignment component 108 may determine relative locations of the poses 302, the poses 308, and/or the poses 602 within the environment using the same coordinate system.

Referring back to the example of FIG. 1, the process 100 may then include the versioning component 114 determining one or more versions associated with the new data 110, where the versions associated with the new data 110 may also be represented by versioning data 116. In some examples, the new data 110 may be generated after an event occurs with respect to the old data 110, such as a period of time elapsing, one or more updates occurring with respect to the environment (e.g., an object and/or feature being added, removed, and/or moved), and/or any other type of event occurring. As such, the versioning component 114 may associate the new data 110 with a new version, such as a second version as compared to the first version associated with the old data 110. For example, and referring again to the example of FIG. 6, the versioning component 114 may determine a second version associated with data generated during the third drive(s) 604, such as version 2.01 (and/or any other version).

The process 100 may then include the mapping component 118 using the new data 110 to again update the map, such as to indicate the locations of objects and/or features located within at least a portion of the environment that is represented by the new data 110. As described herein, in some examples, the mapping component 118 may use any technique to update the map using the new data 110. For example, such as when the new data 110 includes sensor data, the mapping component 118 may project points using the new data 110 in order to determine whether portions of the environment are in the occupied state, the unoccupied state, the unknown state, and/or any other state. The mapping component 118 may then generate a new map that indicates at least the states associated with the portions of the environment determined using this new data 110, where the new map may also be represented by map data 104. Additionally, the mapping component 118 may update the map by merging the map with this updated map, such as by updating one or more portions of the map using the updated map.

For a first example, if the map (and/or the old data 110) indicates that a portion (e.g., a voxel) of the environment includes an occupied state, then the mapping component 118 may confirm that the portion is in the occupied state when the updated map indicates that the portion is also in the occupied state (e.g., a point associated with a ray is located within the portion) or update the portion to an unoccupied state when the updated map indicates that the portion is in the unoccupied state (e.g., a ray passes through the portion). For a second example, if the map (and/or the old data 110) indicates that a portion (e.g., a voxel) of the environment includes an unoccupied state, then the mapping component 118 may confirm that the portion is in the unoccupied state when the updated map indicates that the portion is also in the unoccupied state (e.g., a ray passes through the portion) or update the portion to an occupied state when the updated map indicates that the portion is in the occupied state (e.g., a point associated with a ray is located within the portion).

For a third example, if the map (and/or the old data 110) indicates that a portion (e.g., a voxel) of the environment includes an unknown state, then the mapping component 118 may confirm that the portion is in the unknown state when the updated map indicates that the portion is also in the unknown state (e.g., the new data 110 does not represent the portion such that a ray does not contact the portion), update the portion to an occupied state when the updated map indicates that the portion is in the occupied state (e.g., a point associated with a ray is located within the portion), or update the portion to an unoccupied state when the updated map indicates that the portion is in the unoccupied state (e.g., a ray passes through the portion). Still, for a fourth example, if the map (and/or the old data 110) indicates that a portion (e.g., a voxel) of the environment includes any state, then the mapping component 118 may maintain the state of the portion if the new data 110 indicates that the portion is in the unknown state (e.g., the new data 110 does not represent the portion such that a ray does not contact the portion). While these are just a few example techniques of how the mapping component 118 may update the map using the updated map, in other examples, the mapping component 118 may use additional and/or alternative techniques to update the map.

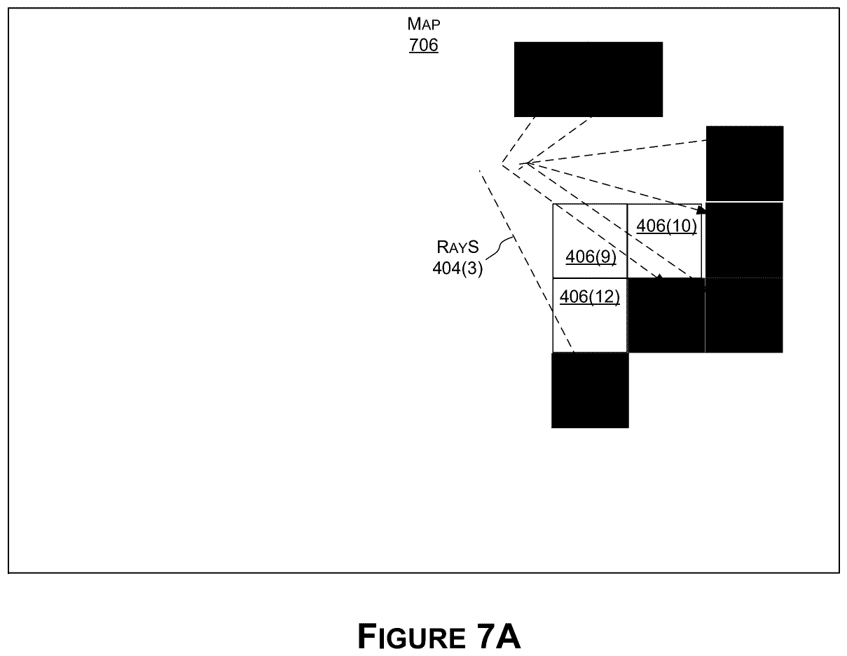

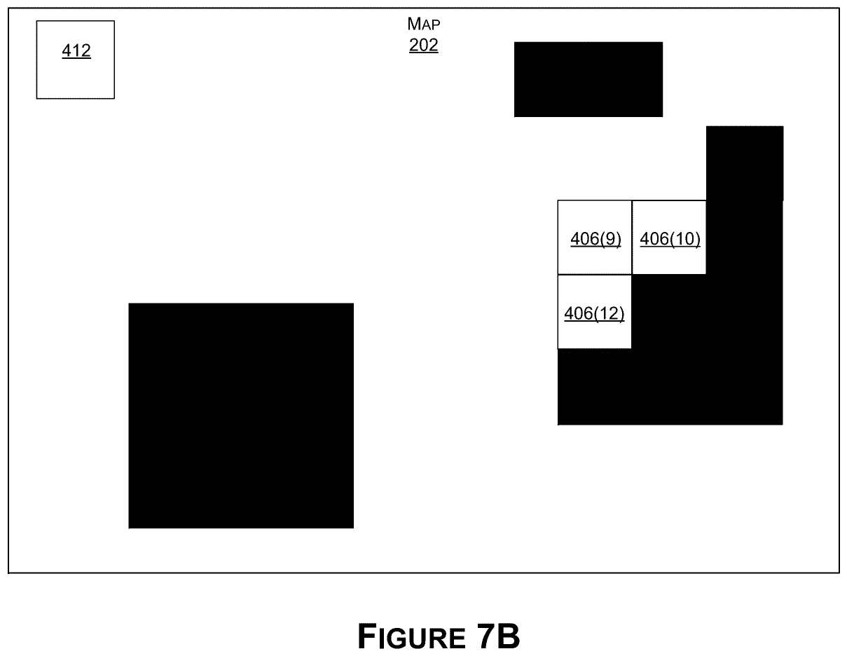

For instance, FIGS. 7A-7B illustrate an example of again updating the map 202 to indicate locations of objects located within the environment 204, in accordance with some embodiments of the present disclosure. As illustrated by the example of FIG. 7A, the mapping component 118 may use the new data to project rays 702 (although only one is labeled for clarity reasons) associated with the environment 204. The mapping component 118 may then determine that portions 406(11), 406(13), 406(14), 410(2), and 704(1)-(3) of the environment 204 are in the occupied state based at least on points associated with the rays 702 being located within the portions 406(11), 406(13), 406(14), 410(2), and 704(1)-(3) (as indicated by the arrows stopping within at least the portions 406(11), 406(13), 406(14), 410(2), and 704(1)-(3)). Additionally, the mapping component 118 may determine that at least portions 406(9), 406(10), and 406(12) of the environment 204 are in the unoccupied state based at least on the rays 702 passing through the portions 406(9), 406(10), and 406(12). The mapping component 118 may then generate an updated map 706 that includes this information.

As shown by the example of FIG. 7B, the mapping component 118 may then update the map 202 using the updated map 706. For instance, the mapping component 118 may update the map 202 to indicate that the portions 406(9), 406(10), and 406(12) of the environment 204 are in the unoccupied state since the rays 702 traversed through the portions 406(9), 406(10), and 406(12) associated with the environment 204. Additionally, the mapping component 118 may update the map 202 to indicate that the portion 410(2) is in the occupied state since one or more points associated with one or more of the rays 702 were located within the portion 410(2) of the environment 204. Furthermore, the mapping component 118 may update the map 202 to indicate that the portions 704(1)-(3) are also in the occluded state since points associated with the rays 702 were also located within the portions 704(1)-(3) of the environment 204.

As further illustrated by the example of FIG. 7B, the mapping component 118 may not update the map 202 that is associated with other portions of the environment 204, such as the portions 406(1)-(8), 406(16), 410(1), and 412, since the new data does not represent those portions of the environment 204. For instance, the rays 702 associated with the new data may not have passed through those portions of the environment 204.

Referring back to the example of FIG. 1, the process 100 may include the mapping component 118 storing the map data 104 representing the map. As described herein, in some examples, the mapping component 118 may only store map data 104 associated with portions of the environment that are in one or more specific states, such as the occupied state. However, in other examples, the mapping component 118 may store map data 104 associated with portions of the environment that are in all of the states, such as the occupied state, the unoccupied state, and the unknown state. Additionally, in some examples, the map data 104 for a portion may represent at least a location (e.g., a 2D location, a 3D location, etc.) of the portion, one or more dimensions associated with the portion, semantic information associated with the portion (e.g., a classification, such as whether the portion is associated with a ground surface or other object), and/or any other information associated with the portion.

In some examples, such as when the map includes a 2D map, the map data 104 may indicate whether 2D locations within the environment are in the occupied state, the unoccupied state, and/or the unknown state. As described herein, in some examples and for 2D map, a portion may be in the unoccupied state as long as an object and/or feature is not located at least a threshold distance above a ground surface associated with the environment. Additionally, in some examples, such as when the map includes a 3D map, the map data 104 may indicate 3D locations (e.g., 3D portions) of the environment that are at least in the occupied state, but may also indicate 3D locations (e.g., 3D portions) of the environment that are in the unoccupied state or in the unknown state.

The process 100 may include the pose component 120 updating the pose graph associated with data 110 that is used to generate and/or update the map. For instance, the pose component 120 may update the pose graph to further include one or more new nodes indicating one or more new poses associated with the new data 110, one or more edges between the new node(s), and/or one or more edges between the new node(s) and the old node(s).

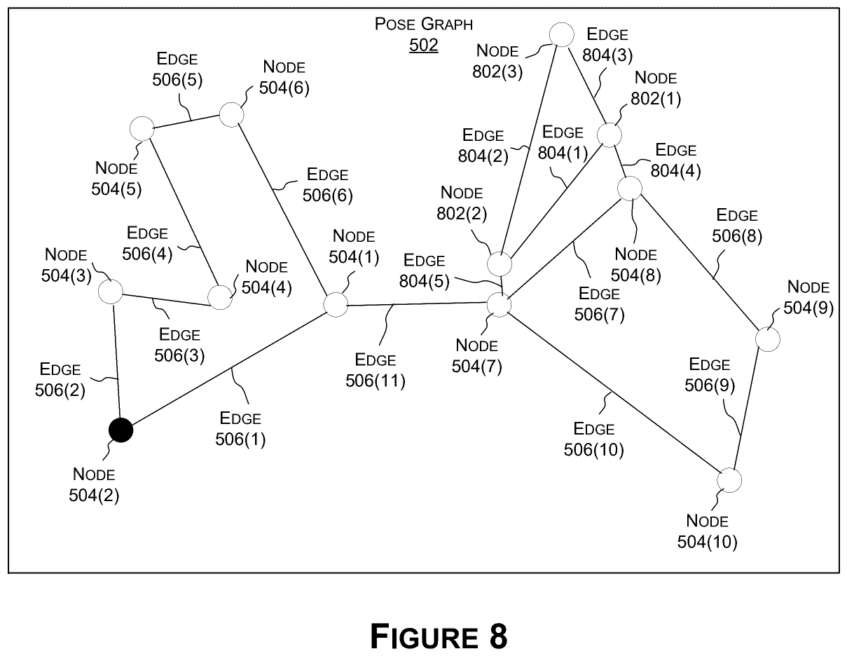

For instance, FIG. 8 illustrates an example of updating the pose graph 502 that is related to the map 202 associated with the environment 204, in accordance with some embodiments of the present disclosure. As shown, the pose component 120 may update the pose graph 502 to include nodes 802(1)-(3) (also referred to singularly as “node 802” or in plural as “nodes 802”), where the nodes 802 are connected together using edges 804(1)-(3). In some examples, the nodes 802(1)-(3) may respectively indicate the poses 602(1)-(3) and the edges 804(1)-(3) may respectively indicate the tracks 606(1)-(3). Additionally, the pose component 120 may update the pose graph 502 to include an edge 804(4) between the node 802(1) and the node 504(8) and an edge 804(5) between the node 802(2) and the node 504(7). Further details about further updating the pose graph 502 are discussed herein.

Referring back to the example of FIG. 1, the process 100 may continue to repeat as new data 110 is generated using the machine(s) 112 in order to continue updating the map and/or the pose graph. As such, by performing these processes, the map and/or the pose graph may remain updated in order to represent the current layout of the environment. Additionally, the process 100 may include sending at least a portion of the map data 104 to one or more additional machines 124 (e.g., an example autonomous vehicle 1600) located within the environment. This way, the additional machine(s) 124 may use the map in order to perform one or more operations within the environment. For example, the machine(s) 124 may use the map in order to determine one or more trajectories for navigating within the environment, such as to avoid colliding with the objects and/or features within the environment.

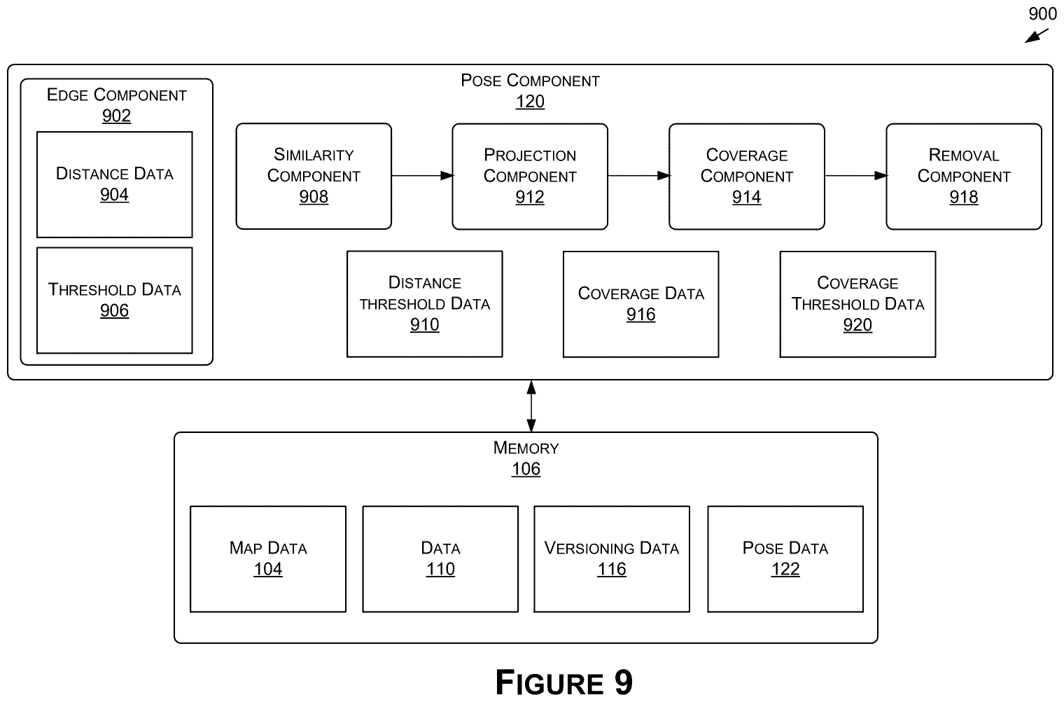

For instance, FIG. 9 illustrates an example data flow diagram for a process 900 of updating a pose graph using versioned data, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1600 of FIGS. 16A-16D, example computing device 1700 of FIG. 17, and/or example data center 1800 of FIG. 18.

As shown, the process 900 may include the pose component 120 using an edge component 902 to generate one or more edges between one or more nodes of the pose graph. In some examples, to determine whether a new edge should be generated between two nodes, the edge component 902 may determine a first distance (e.g., a graph distance) indicating a number of edges between the nodes and a second distance (e.g., a physical distance) indicating an actual distance between the nodes within the environment (e.g., based at least on the coordinates of the nodes within the environment), where the distances may be represented by distance data 904. The edge component 902 may then use the first distance and the second distance to determine whether to generate the new edge between the nodes.

For example, the edge component 902 may divide the first distance by the second distance and then use the solution to that calculation to determine whether to generate the new edge, such as by using one or more thresholds represented by threshold data 906. For example, the edge component 902 may determine to generate the new edge when the solution satisfies (e.g., is equal to or greater than) a threshold or determine not to generate the new edge when the solution does not satisfy (e.g., is less than) the threshold. In some examples, the edge component 902 may perform such processes since new edges may be needed between nodes for which there is a small physical distance within the environment, but a large number of edges between the nodes. In such examples, this may be to help reduce the number of transformations that is needed when performing one or more of the processes described herein with respect to the pose graph, such as when updating the map using the data 110 associated with the nodes.

As described herein, when determining to add a new edge between nodes, the edge component(s) 902 may use one or more additional criteria. For instance, in some examples, the edge component(s) 902 may use descriptors associated with the nodes to verify that the nodes are associated with a similar space, such as a same environment, a same portion (e.g., room, etc.) within the environment, and/or so forth. For a first example, if two descriptors for two nodes indicate that the two nodes are within a similar space, such as a room of the environment, then the edge component(s) 902 may still determine to add the edge between the nodes (e.g., using one or more of the techniques described herein). However, if the descriptors for the two nodes indicate that the nodes are not within a similar space, such as different rooms of the environment, then the edge component(s) 902 may determine not to add the edge between the nodes.

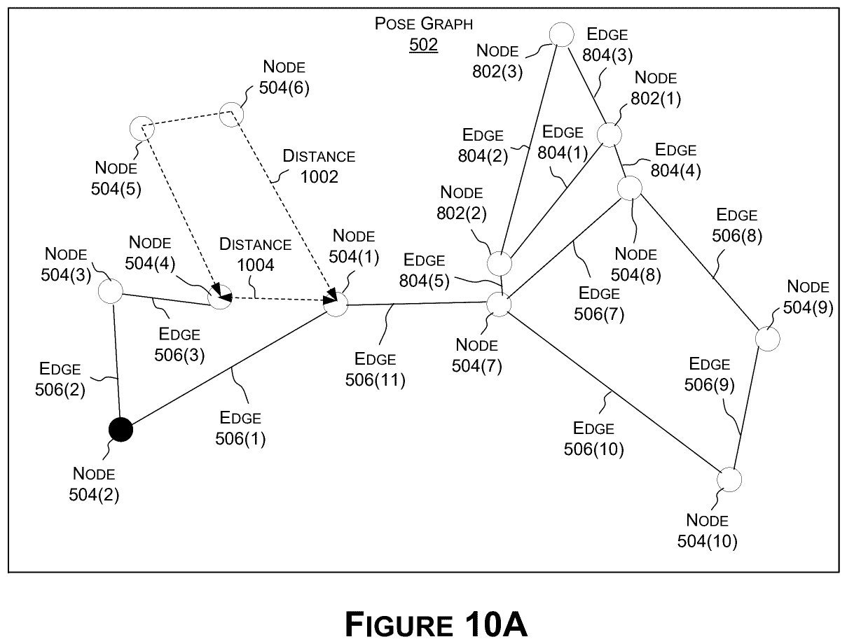

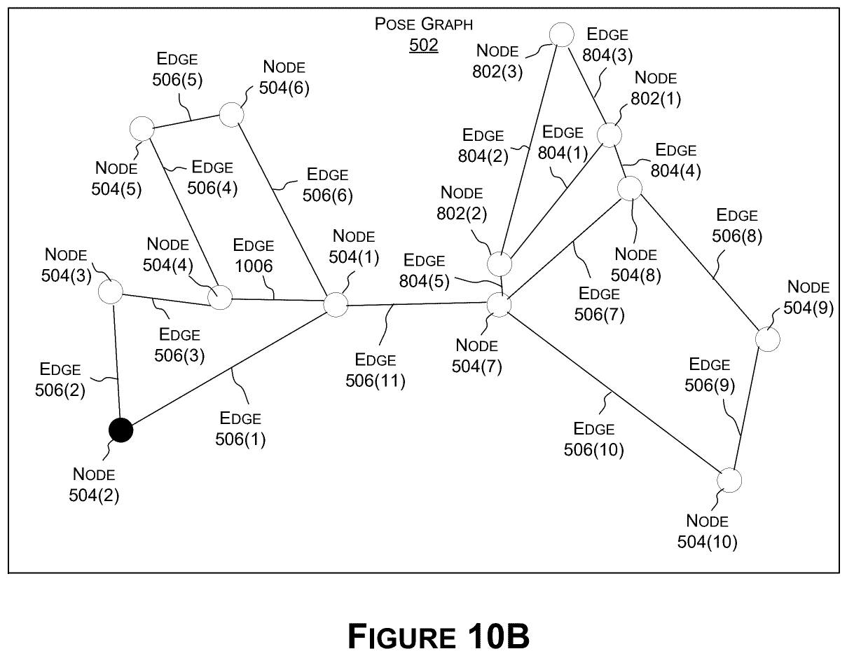

For instance, FIGS. 10A-10B illustrate an example of generating a new edge between nodes of a pose graph, in accordance with some embodiments of the present disclosure. As illustrated by the example of FIG. 10A, the edge component 902 may determine a first distance 1002(1) that is associated with a number of edges between the node 504(1) and the node 504(4), which includes three in the example of FIG. 10A. Additionally, the edge component 902 may determine a second distance 1004 that is associated with a physical distance in the environment 204 between the pose 302(1) associated with the node 504(1) and the pose 302(4) associated with the node 504(4). In some examples, the edge component 902 uses the coordinates associated with the pose 302(1) and the coordinates associated with the pose 302(4) to determine the second distance 1004. The edge component 902 may then use the first distance 1002 and the second distance 1004 to determine whether to generate a new edge between the node 504(1) and the node 504(4).

For instance, and as illustrated by the example of FIG. 10B, the edge component 902 may determine to generate a new edge 1006 between the node 504(1) and the node 504(4) using the first distance 1002 and the second distance 1004. In some examples, the edge component 902 may then perform similar processes to determine whether to generate one or more additional edges between one or more additional pairs of nodes 504 and 802.

Referring back to the example of FIG. 9, the process 100 may include the pose component 120 performing one or more techniques to remove one or more nodes (e.g., one or more old nodes) from the pose graph (e.g., the base pose graph) when one or more new nodes associated with new data 110 added to the base pose graph, where the one or more new nodes may be associated with a newly generated pose graph. For instance, and for an old node, the process 100 may include the pose component 120 using a similarity component 908 to identify one or more new nodes from the new pose graph that are related to the old node from the base pose graph. As described herein, in some examples, the similarity component 908 may identify the new node(s) that is related to the old node using one or more threshold distances represented by distance threshold data 910. In some examples, a threshold distance may be associated with the sensor data 110 used to generate the map. For example, a threshold distance may include a range of the sensor (e.g., the LiDAR sensor) associated with the data 110. However, in other examples, a threshold distance may include any other distance.

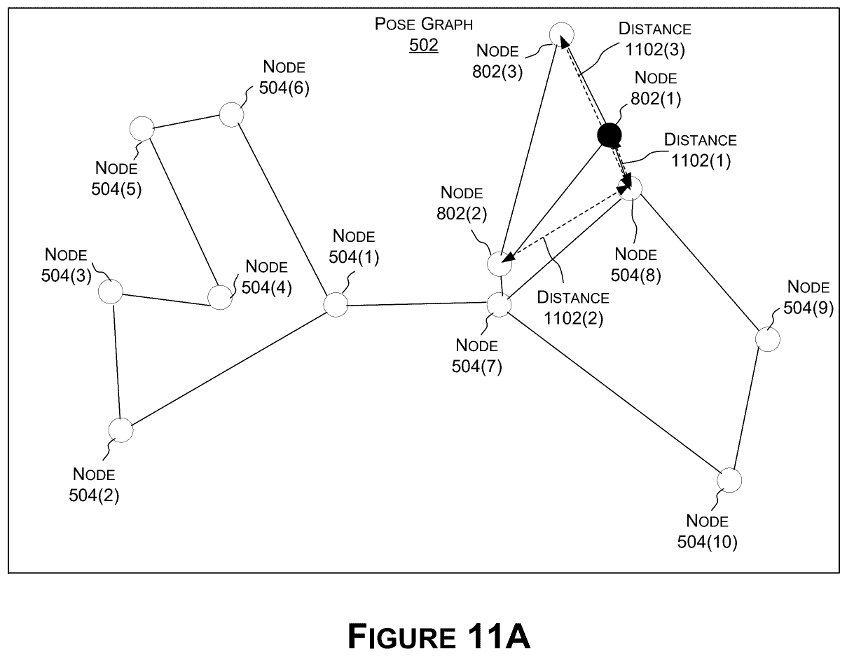

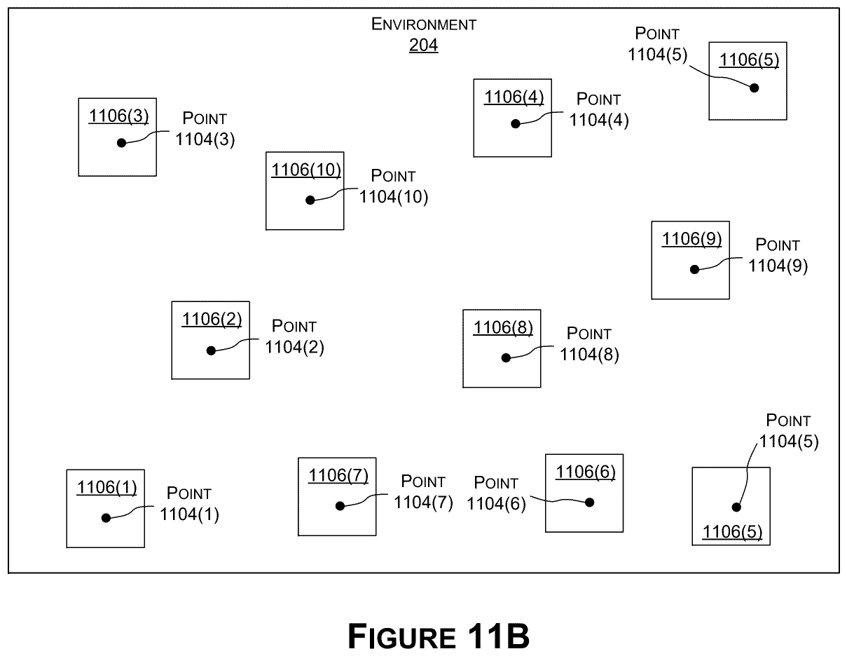

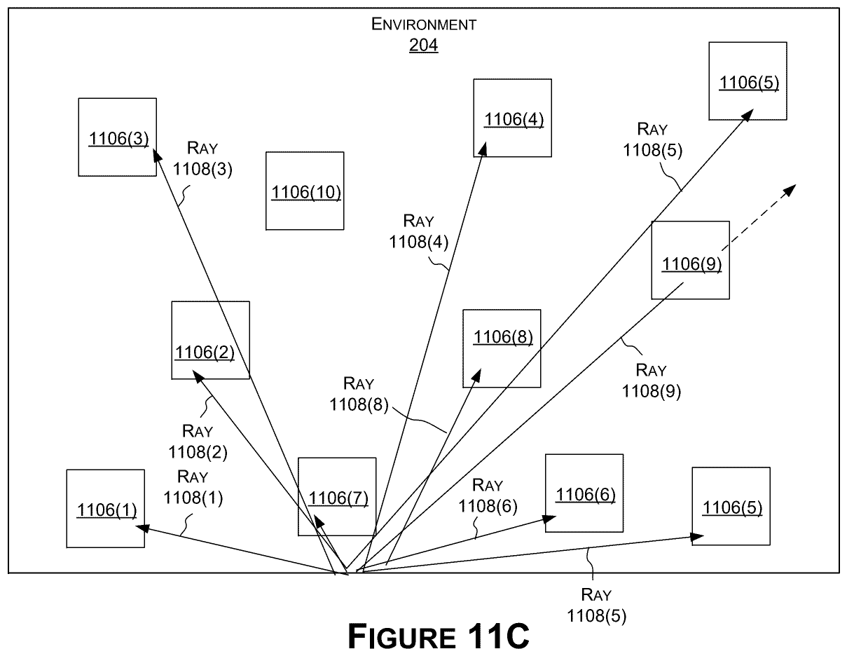

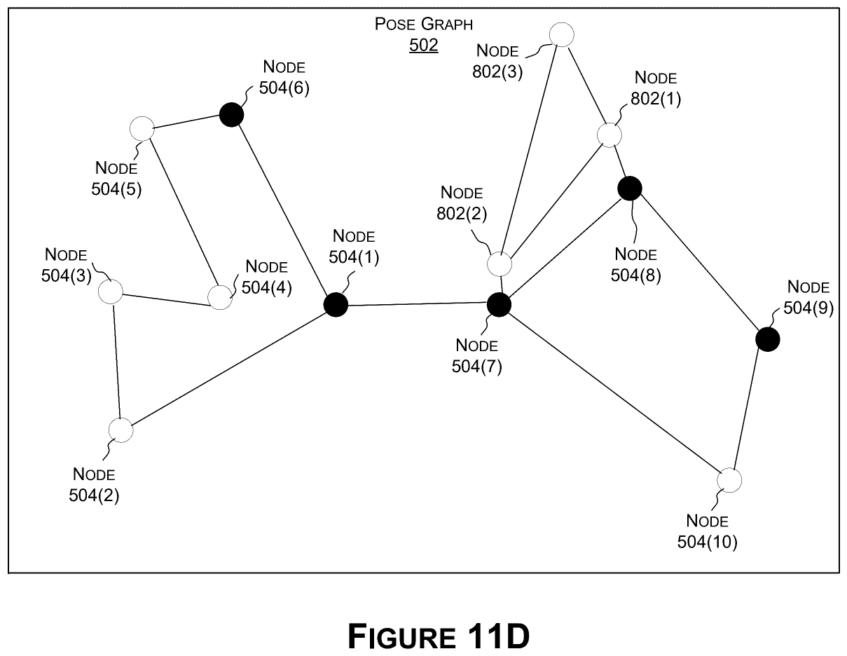

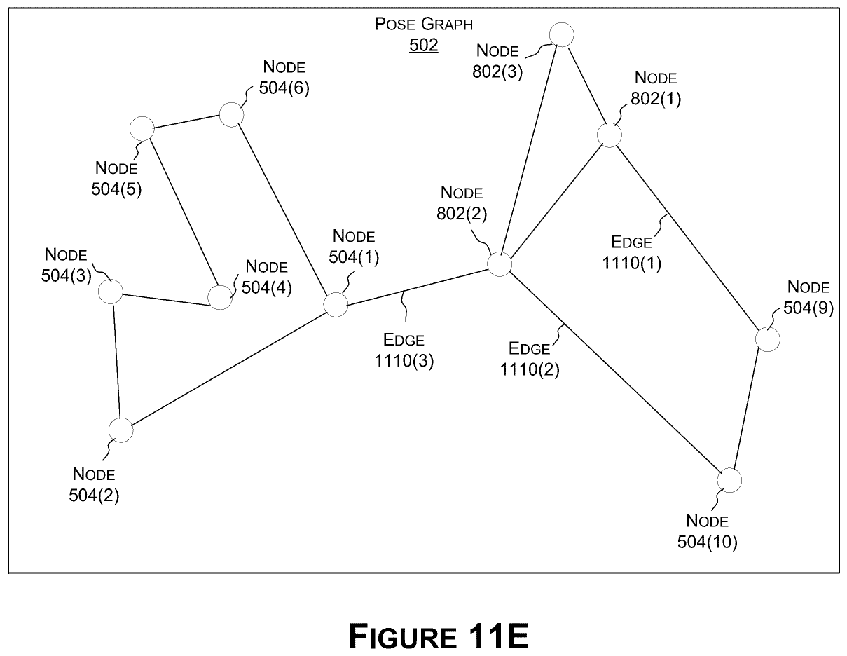

For instance, FIG. 11A illustrates an example of identifying one or more new nodes that are related to an old node for use during a removal process, in accordance with some embodiments of the present disclosure. As shown, the similarity component 908 may determine distances 1102(1)-(3) (also referred to singularly as “distance 1102” or in plural as “distances 1102”) between the node 504(8) and the nodes 802. The similarity component 908 may then use the distances 1102 to determine that at least the node 802(1) is related to the node 504(8), which is indicated by the shading. For example, the similarity component 908 may determine that the distance 1102(1) is less than or equal to a threshold distance while the distances 1102(2)-(3) are greater than the threshold distance.

Referring back to the example of FIG. 9, the process 900 may include the pose component 120 using a projection component 912 to project points within the environment using at least the portion of the old data 110 that is associated with the old node. The projection component 912 may then determine portions of the environment that are associated with the points, such as voxels (and/or any other 2D and/or 3D shapes) that surround the points. Additionally, the projection component 912 may project rays into the environment using at least the portion of the new data 110 that is associated with the new node(s) that is related to the old node. In some examples, the projection component 912 may perform one or more additional processes before projecting the rays into the environment. For example, the projection component 912 may remove old data 110 and/or new data 110 that is associated with one or more dynamic objects before projecting the rays into the environment. This way, the rays, points, and/or portions may only be associated with static objects within the environment.

The process 900 may then include the pose component 120 using a coverage component 914 to determine an amount of coverage associated with the old node, where the amount of coverage may be represented by coverage data 916. In some examples, the coverage component 914 may determine the amount of coverage by determining a total number of portions within the environment and a number of portions that are contacted by projected rays. For example, the coverage component 914 may determine the amount of coverage as a percentage by dividing the number of covered portions by the total number of portions. However, in other examples, the coverage component 914 may determine the amount of coverage using any other technique. In any example, the amount of coverage may be with understanding new information in new data 110 (compared to old data 110) that is useful for mapping. For instance, since the old data 110 is aligned with the new data 110, the amount of coverage may indicate changes that occurred between the old data 110 and the new data 110. As such, this amount of coverage may be useful when performing the updates to the map, which are described herein. For instance, if new data 110 has updated information as compared to the old data 110, then the map may be updated. Additionally, if the new data 110 has the same information as compared to the old data 110, then the old data 110 may be removed. However, if the new data 110 does not have information (e.g., the new data 110 does not cover an area of the environment and/or is obstructed), then the old data 110 may be kept.

For instance, FIG. 11B illustrates an example of projecting points within the environment 204 (e.g., a representation of the environment 204) in order to identify portions of the environment 204 associated with the node 504(8), in accordance with some embodiments of the present disclosure. As shown, the projection component 912 may project rays using the data that is associated with the node 504(8) in order to determine the locations of points 1104(1)-(10) (also referred to singularly as “point 1104” or in plural as “points 1104”). The projection component 912 may then determine portions 1106(1)-(10) (also referred to singularly as “portion 1106” or in plural as “portions 1106”) of the environment 204 using the points 1104. In the example of FIG. 11B, the portions 1106 may include voxels that surround the points 1104. However, in other examples, the portions 1106 may include any other 3D shape that at least partially surrounds the points 1104. Additionally, while the example of FIG. 11B illustrates projecting ten points 1104 in order to determine ten portions 1106 of the environment 204, in other examples, the projection component 912 may project any number of points to determine any number of portions 1106 of the environment 204.

Next, and as illustrated by the example of FIG. 11C, the projection component 912 may project rays 1108(1)-(9) (also referred to singularly as “ray 1108” or in plural as “rays 1108”) using the new data that is associated with the node 802(1). While the example of FIG. 11C illustrates the projection component 912 as projecting nine rays 1108 into the environment 204, in other examples, the projection component 912 may project any number of rays into the environment 204. In the example of FIG. 11C, the coverage component 914 may then determine an amount of coverage using the portions 1106 of the environment and the rays 1108. For instance, the coverage component 914 may determine that the portions 1106(1)-(9) of the environment 204 are covered by the new data based at least on the rays 1108(1)-(8) including points within the portions 1106(1)-(8) and the ray 1108(9) passing through the portion 1106(9). However, the coverage component 914 may determine that the portion 1106(10) of the environment 204 is not covered based at least on none of the rays 1108 contacting the portion 1106(10).

Referring back to the example of FIG. 9, in some examples, the coverage component 914 may use additional and/or alternative processes to determine the amount of coverage. For instance, in some examples, one or more portions (e.g., one or more voxels) within the environment may become obstructed due to one or more factors, such as one or more object and/or features being moved to cover the portion(s). As such, in some examples, the coverage component 914 may use one or more techniques to determine whether to include the portion(s) in the calculations when determining the amount of coverage. For example, and for a missed portion, the coverage component 914 may determine a number of rays that are projected proximate to the missed portion and/or contact other portions of the environment that are proximate to the missed portion. The coverage component 914 may then use the number of rays to determine whether to include the missed portion in the total number of portions. For example, the coverage component 914 may determine to include the missed portion in the total number of portions when the number of rays is less than a threshold number of rays and determine to remove the missed portion from the total number of portions when the number of rays is equal to or greater than the threshold number of rays.

The process 900 may include the pose component 120 using a removal component 918 to determine whether to remove one or more nodes associated with the base pose graph. For instance, and with regard to the old node from the examples above, the removal component 918 may determine to remove the old node when the amount of coverage satisfies (e.g., is equal to or greater than) a threshold amount of coverage or determine not to remove the old node when the amount of coverage does not satisfy (e.g., is less than) the threshold amount of coverage, where the threshold amount of coverage may be represented by coverage threshold data 920. As described herein, the threshold amount of coverage may include, but is not limited to, 80%, 85%, 90%, 95%, and/or any other percentage. The pose component 120 may then continue to perform these processes in order to determine whether to remove one or more additional old nodes from the base pose graph.

In some examples, the pose component 120 may perform these processes of removing one or more old nodes from the base pose graph (and/or a database) since the pose component 120 determines that the old node(s) includes a redundant node(s). This is because the new data that was used to update the map covers the same portion of the environment that the old data associated with the redundant node(s) also covered within the environment. As such, the pose component 102 may remove the initial node(s) and/or the old data 110 (e.g., one or more previous version of data) associated with the old node(s) such that the old data 110 and/or the old data 110 may not be used again when performing additional updates to the map. Rather, the new data 110 that better represents that portion of the environment may be used when updating the map, such as any updates that occurred to that portion of the environment.

For instance, FIGS. 110D-11E illustrate an example of removing one more of the nodes 504 from the pose graph 502, in accordance with some embodiments of the present disclosure. As illustrated by the example of FIG. 11D, the removal component 918 may determine, from the coverage component 914 and/or the coverage data 916, the amounts of coverage associated with the nodes 504. For example, the removal component 918 may determine that the nodes 504(7)-(8) are associated with amounts of coverage that are between 90%-100%, which is indicated by the dark shading, the nodes 504(1), 506(6), and 504(9) are associated with amounts of coverage that are between 80% and 90%, which is indicated by the grey shading, and the nodes 504(2)-(5) and 504(10) are associated with amounts of coverage that are less than 80%, which is indicated by the white shading.

As such, and as illustrated by the example of FIG. 11E, the removal component 918 may use the amounts of coverage to determine one or more of the nodes 504 to remove. For example, and as shown, the removal component 918 may determine to remove the nodes 504 that are associated with amounts of coverage that satisfy a threshold amount of coverage of 90%. As such, the removal component 918 may determine to remove the nodes 504(7)-(8) from the pose graph 502. Additionally, based at least on removing the nodes 504(7)-(8), the edge component 902 may use one or more of the processes described herein to generate new edges 1110(1)-(3) that again connect the remaining nodes 504 and 802.

Referring back to the example of FIG. 1, in some examples, the process 900 may include the removal component 918 removing at least a portion of the data 110 that is stored in the memory 106, where the at least the portion of the data 110 is associated with the removed node(s). This way, the memory 106 may store the most updated data 110 associated with the current nodes that are included in the pose graph. Additionally, in some examples, the process 900 may continue to repeat as the machine(s) 112 continues generating new data 110 and/or the mapping component 118 continues updating the map. This way, the pose graph continues to represent the most updated poses associated with the most updated data 110 that may be used to generate and/or update the map.

As described herein, at least a portion of the process 100 and/or at least a portion of the process 900 may be performed using at least one of an example autonomous vehicle 1600, an example computing device 1700, and/or an example data center 1800, which are described in more detail herein. For example, the creation component 102, the alignment component 108, the versioning component 114, the mapping component 118, the pose component 120, and/or the memory 106 may be stored in one or more memories and/or executed by one or more processors of an example autonomous vehicle 1600, an example computing device 1700, and/or an example data center 1800.

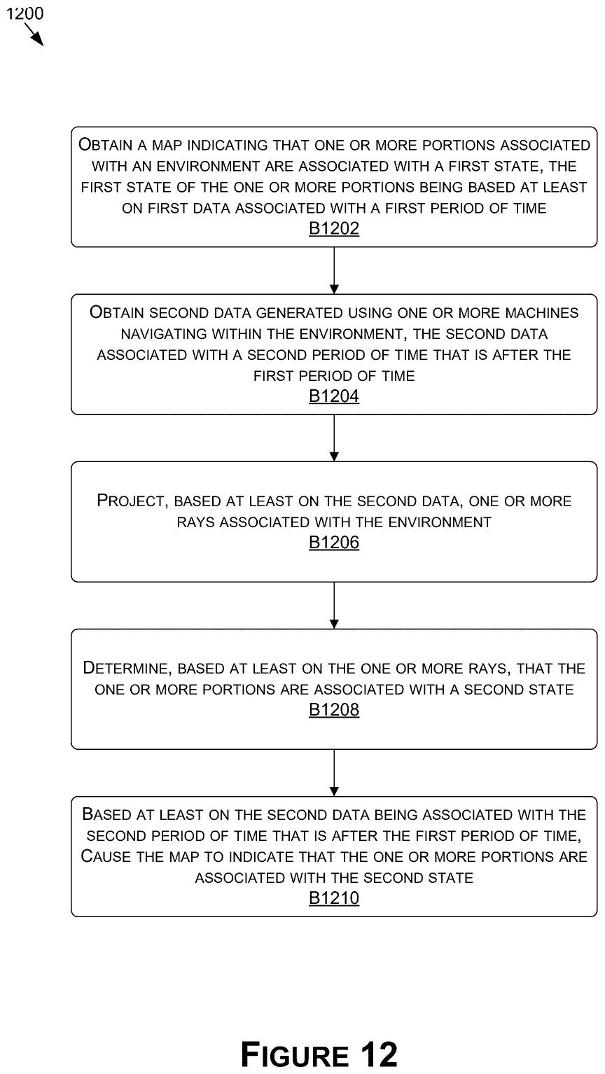

Now referring to FIGS. 12-15, each block of methods 1200, 1300, 1400, and 1500, described herein, comprises a computing process that may be performed using any combination of hardware, firmware, and/or software. For instance, various functions may be carried out by a processor executing instructions stored in memory. The methods 1200, 1300, 1400, and 1500 may also be embodied as computer-usable instructions stored on computer storage media. The methods 1200, 1300, 1400, and 1500 may be provided by a standalone application, a service or hosted service (standalone or in combination with another hosted service), or a plug-in to another product, to name a few. In addition, these methods 1200, 1300, 1400, and 1500 are described, by way of example, with respect to FIGS. 1 and 9. However, these methods 1200, 1300, 1400, and 1500 may additionally or alternatively be executed by any one system, or any combination of systems, including, but not limited to, those described herein.

FIG. 12 illustrates a flow diagram showing a method 1200 for performing incremental map updates using versioned data, in accordance with some embodiments of the present disclosure. The method 1200, at block B1202, may include obtaining a map indicating that one or more portions associated with an environment are associated with a first state, the first state of the one or more portions being based at least on first data associated with a first period of time. For instance, the mapping component 118 may receive the map represented by the map data 104. As described herein, the map may indicate that the portion(s) associated with the environment is associated with the first state, where the first state is determined using the first data 110 generated during the first period of time. As described herein, the first state may include an occupied state, an unoccupied, state, an unknown state, and/or any other state. Additionally, the portion(s) may include one or more voxels and/or any other type of 2D and/or 3D shape. Furthermore, the first data 110 may include sensor data generated using one or more sensors of the machine(s) 112.

The method 1200, at block B1204, may include obtaining second data generated using one or more machines within the environment, the second data associated with a second period of time that is after the first period of time. For instance, the mapping component 118 may obtain the second data 110 generated using the machine(s) 112 located within the environment. As described herein, in some examples, the second data 110 may include sensor data generated using one or more sensors of the machine(s) 112. Additionally, in some examples, the second data 110 may be generated after an event, such that the second data 110 includes a later version as compared to the first data 110.

The method 1200, at block B1206, may include projecting, based at least on the second data, one or more rays associated with the environment. For instance, the mapping component 118 may project the ray(s) associated with the environment using at least the second data 110. In some examples, before projecting the ray(s), the alignment component 108 may align the second data 110 with respect to the first data 110 and/or the environment.

The method 1200, at block B1208, may include determining, based at least on the one or more rays, that the one or more portions are associated with a second state. For instance, the mapping component 118 may determine, based at least on the ray(s), that the portion(s) associated with the environment are associated with the second state. As described herein, and for a portion, the mapping component 118 may make the determination based at least on whether a ray contacts the portion, passes through the portion, and/or does not contact the portion. For example, the mapping component 118 may determine that the portion is in the occupied state when the ray includes a point within the portion, the unoccupied state when the ray passes through the portion, or the unknown state when the ray does not contact the portion.

The method 1200, at block B1210, may include, based at least on the second data being associated with the second period of time that is after the first period of time, causing the map to indicate that the one or more portions are associated with the second state. For instance, the mapping component 118 may update the map such that the map indicates that the portion(s) is associated with the second state. Additionally, in some examples, the method 1200 may continue to repeat as the mapping component 118 continues to receive additional data 110 generated using the machine(s) 112.

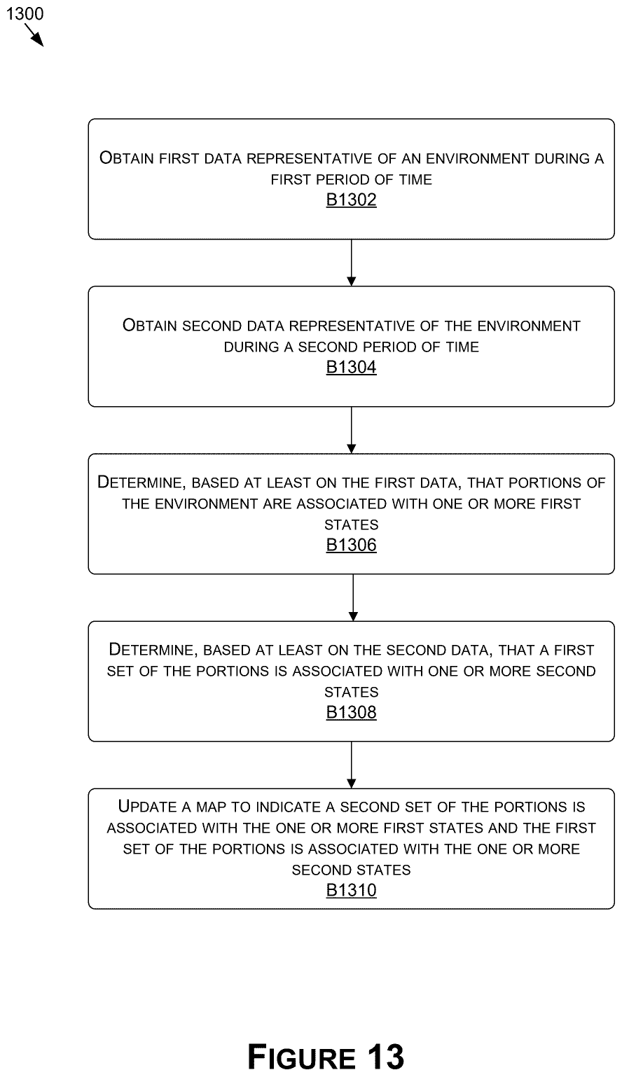

FIG. 13 illustrates a flow diagram showing another method 1300 for performing incremental map updates using versioned data, in accordance with some embodiments of the present disclosure. The method 1300, at block B1302, may include obtaining first data representative of an environment during a first period of a time. For instance, the mapping component 118 may obtain the first data 110 representing the environment during the first period of time. As described herein, in some examples, the first data 110 may be generated using one or more first machines 112 navigating within the environment during the first period of time. Additionally, in some examples, the first data 110 may have been used to generate and/or update a map represented by the map data 104.

The method 1300, at block B1304, may include obtaining second data representative of the environment during a second period of time. For instance, the mapping component 118 may obtain the second data 110 representing the environment during the second period of time. As described herein, in some examples, the second data 110 may be generated using one or more second machines 112 navigating within the environment during the second period of time. Additionally, in some examples, the second data 110 may be generated after an event, such that the second data 110 includes a later version as compared to the first data 110.

The method 1300, at block B1306, may include determining, based at least on the first data, that portions of the environment are associated with one or more first states. For instance, the mapping component 118 may determine, using the first data 110, that the portions (e.g., voxels) of the environment are associated with the first state(s). As described herein, in some examples, the mapping component 118 may make the determination based at least on projecting points associated with the environment using the first data 110. Additionally, the first state(s) may include, but is not limited to, an occupied state, an unoccupied state, an unknown state, and/or any other type of state.

The method 1300, at block B1308, may include determining, based at least on the second data, that a first set of the portions is associated with one or more second states. For instance, the mapping component 118 may determine, using the second data 110, that the first set of the portions of the environment is associated with the second state(s). As described herein, in some examples, the mapping component 118 may make the determination based at least on projecting points associated with the environment using the second data 110. Additionally, the second state(s) may include, but is not limited to, the occupied state, the unoccupied state, the unknown state, and/or any other type of state.

The method 1300, at block B1310, may include updating a map to indicate that a second set of the portions is associated with the one or more first states and the first set of the portions is associated with the one or more second states. For instance, the mapping component 118 may update the map to indicate that the second set of the portions is associated with the first state(s) and the first set of the portions is associated with the second state(s). This way, the mapping component 118 may determine updated states for the first set of the portions since the second data 110, which includes a newer version as compared to the first data 110, represents the first set of the portions. However, the mapping component 118 may not update the second set of the portions since the second data 110 may not represent the second set of the portions (e.g., the rays associated with the second data 110 do not contact the second set of the portions).

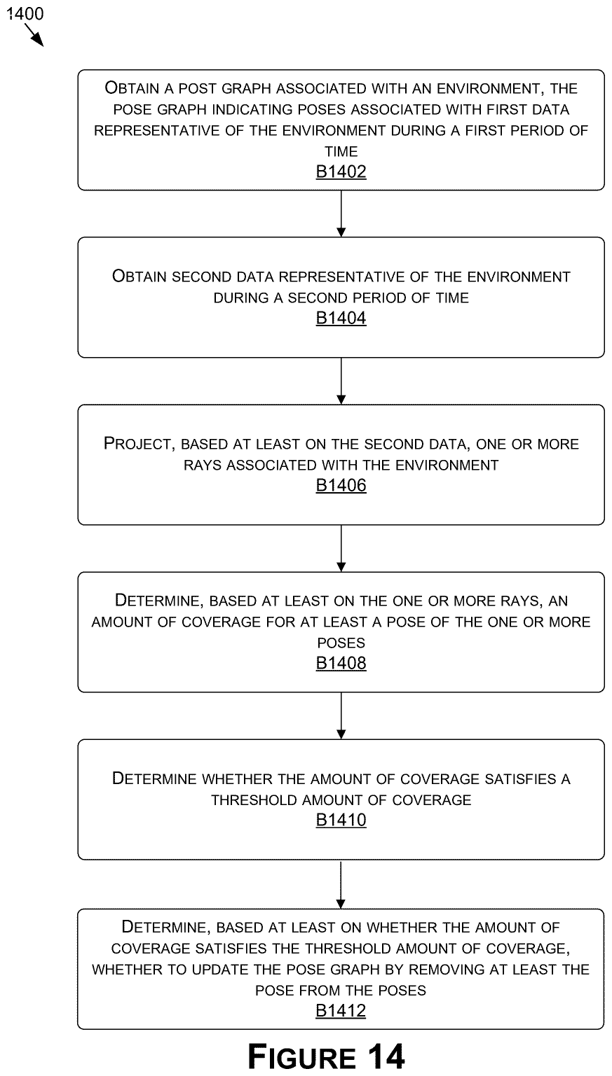

FIG. 14 illustrates a flow diagram showing a method 1400 for updating a pose graph using versioned data, in accordance with some embodiments of the present disclosure. The method 1400, at block B1402, may include obtaining a pose graph associated with an environment, the pose graph indicating poses associated with first data representative of the environment during a first period of time. For instance, the pose component 120 may obtain the pose data 122 representing the pose graph associated with the environment. As described herein, the pose graph may indicate the poses associated with the first data 110 representative of the environment during the first period of time. Additionally, in some examples, the first data 110 may have been used to generate and/or update a map associated with the environment.

The method 1400, at block B1404, may include obtaining second data representative of the environment during a second period of time. For instance, the pose component 120 may obtain the second data 110 representative of the environment during the second period of time. As described herein, in some examples, the second data 110 may be generated after an event, such that the second data 110 includes a later version as compared to the first data 110. Additionally, in some examples, the second data 110 may have been used to update the map associated with the environment.

The method 1400, at block B1406, may include projecting, based at least on the second data, one or more rays associated with the environment. For instance, the pose component 120 (e.g., the projection component 912) may project the ray(s) associated with the environment using the second data 110. In some examples, before projecting the ray(s), the pose component 120 (e.g., the similarity component 908) may determine that the second data 110 is related to the one or more of the poses, such as by using one or more distances between one or more new poses associated with the second data 110 and the one or more poses. Additionally, in some examples, before projecting the ray(s), the pose component 120 may determine that the second data 110 does not represent one or more dynamic objects.

The method 1400, at block B1408, may include determining, based at least on the one or more rays, an amount of coverage for at least a pose of the one or more poses. For instance, the pose component 120 (e.g., the coverage component 914) may determine the amount of coverage associated with the pose using the ray(s). As described herein, in some examples, the pose component 120 may determine the amount of coverage by initially determining portions (e.g., voxels) associated with the environment using a portion of the first data 110 that is associated with the pose. The pose component 120 may then determine a total number of the portions along with a number of the portions that are contacted by the ray(s). Additionally, the pose component 120 may then determine the amount of coverage based at least on the number of contacted portions and the total number of portions.

The method 1400, at block B1410, may include determining whether the amount of coverage satisfies a threshold amount of coverage. For instance, the pose component 120 (e.g., the removal component 918) may determine whether the amount of coverage satisfies the threshold amount of coverage. As described herein, in some examples, the pose component 120 may determine that the amount of coverage satisfies the threshold amount of coverage when the amount of coverage is equal to or greater than the threshold amount of coverage, or the pose component 120 may determine that the amount of coverage does not satisfy the threshold amount of coverage when the amount of coverage is less than the threshold amount of coverage.

The method 1400, at block B1412, may include determining, based at least on whether the amount of coverage satisfies the threshold amount of coverage, whether to update the pose graph by removing at least the pose from the poses. For instance, the pose component 120 (e.g., the removal component 918) may determine whether to remove the pose from the pose graph based at least on whether the amount of coverage satisfies the threshold amount of coverage. As described herein, in some examples, the pose component 120 may determine to remove the pose when the amount of coverage satisfies the threshold amount of coverage or determine not to remove the pose when the amount of coverage does not satisfy the threshold amount of coverage.

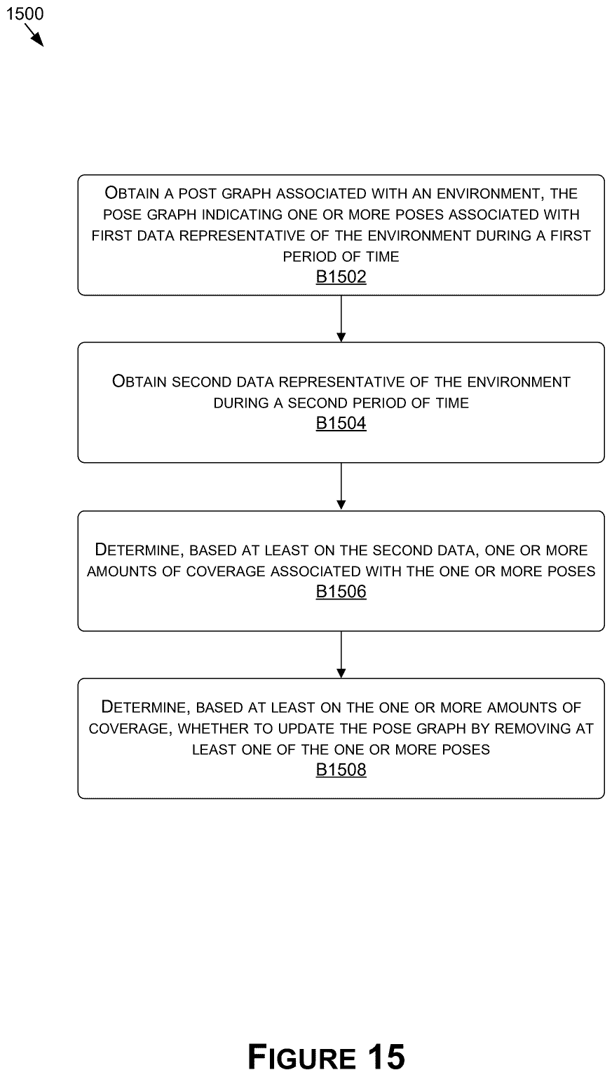

FIG. 15 illustrates a flow diagram showing another method 1500 for updating a pose graph using versioned data, in accordance with some embodiments of the present disclosure. The method 1500, at block B1502, may include obtaining a pose graph associated with an environment, the pose graph indicating one or more poses associated with first data representative of the environment during a first period of time. For instance, the pose component 120 may obtain the pose data 122 representing the pose graph associated with the environment. As described herein, the pose graph may indicate the pose(s) associated with the first data 110 representative of the environment during the first period of time. Additionally, in some examples, the first data 110 may have been used to generate and/or update a map associated with the environment.

The method 1500, at block B1504, may include obtaining second data representative of the environment during a second period of time. For instance, the pose component 120 may obtain the second data 110 representative of the environment during the second period of time. As described herein, in some examples, the second data 110 may be generated after an event, such that the second data 110 includes a later version as compared to the first data 110. Additionally, in some examples, the second data 110 may have been used to update the map associated with the environment.

The method 1500, at block B1506, may include determining, based at least on the second data, one or more amounts of coverage associated with the one or more poses. For instance, the pose component 120 (e.g., the coverage component 914) may determine the amount(s) of coverage associated with the pose(s) using the second data 110. As described herein, in some examples, to determine an amount of coverage associated with a pose, the pose component 120 may determine portions of the environment (e.g., voxels located within the environment) using at least a portion of the first data 110. The pose component 120 may then project rays associated with the environment using at least a portion of the second data 110. Additionally, the pose component 120 may determine the amount of coverage based at least on a total number of the portions and a number of contacted portions associated with the rays.

The method 1500, at block B1508, may include determining, based at least on the one or more amounts of coverage, whether to update the pose graph by removing at least one of the one or more poses. For instance, the pose component 120 (e.g., the removal component 918) may determine whether to remove at least one of the pose(s) using the amount(s) of coverage. As described herein, and for a pose, the pose component 120 may determine to remove the pose when the amount of coverage satisfies the threshold amount of coverage or determine not to remove the pose when the amount of coverage does not satisfy the threshold amount of coverage. The pose component 120 may then update the pose graph when the pose component 120 determines to remove the at least the one of the pose(s).

### Example Autonomous Vehicle

FIG. 16A is an illustration of an example autonomous vehicle 1600, in accordance with some embodiments of the present disclosure. The autonomous vehicle 1600 (alternatively referred to herein as the “vehicle 1600”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1600 may be capable of functionality in accordance with one or more of Level 3-Level 5 of the autonomous driving levels. The vehicle 1600 may be capable of functionality in accordance with one or more of Level 1-Level 5 of the autonomous driving levels. For example, the vehicle 1600 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1600 or other machine, such as being fully autonomous, being highly autonomous, being conditionally autonomous, being partially autonomous, providing assistive autonomy, being semi-autonomous, being primarily autonomous, or other designation.

The vehicle 1600 may include components such as a chassis, a vehicle body, wheels (e.g., 2, 4, 6, 8, 18, etc.), tires, axles, and other components of a vehicle. The vehicle 1600 may include a propulsion system 1650, such as an internal combustion engine, hybrid electric power plant, an all-electric engine, and/or another propulsion system type. The propulsion system 1650 may be connected to a drive train of the vehicle 1600, which may include a transmission, to enable the propulsion of the vehicle 1600. The propulsion system 1650 may be controlled in response to receiving signals from the throttle/accelerator 1652.

A steering system 1654, which may include a steering wheel, may be used to steer the vehicle 1600 (e.g., along a desired path or route) when the propulsion system 1650 is operating (e.g., when the vehicle is in motion). The steering system 1654 may receive signals from a steering actuator 1656. The steering wheel may be optional for full automation (Level 5) functionality.

The brake sensor system 1646 may be used to operate the vehicle brakes in response to receiving signals from the brake actuators 1648 and/or brake sensors.

Controller(s) 1636, which may include one or more system on chips (SoCs) 1604 (FIG. 16C) and/or GPU(s), may provide signals (e.g., representative of commands) to one or more components and/or systems of the vehicle 1600. For example, the controller(s) may send signals to operate the vehicle brakes via one or more brake actuators 1648, to operate the steering system 1654 via one or more steering actuators 1656, to operate the propulsion system 1650 via one or more throttle/accelerators 1652. The controller(s) 1636 may include one or more onboard (e.g., integrated) computing devices (e.g., supercomputers) that process sensor signals, and output operation commands (e.g., signals representing commands) to enable autonomous driving and/or to assist a human driver in driving the vehicle 1600. The controller(s) 1636 may include a first controller 1636 for autonomous driving functions, a second controller 1636 for functional safety functions, a third controller 1636 for artificial intelligence functionality (e.g., computer vision), a fourth controller 1636 for infotainment functionality, a fifth controller 1636 for redundancy in emergency conditions, and/or other controllers. In some examples, a single controller 1636 may handle two or more of the above functionalities, two or more controllers 1636 may handle a single functionality, and/or any combination thereof.

The controller(s) 1636 may provide the signals for controlling one or more components and/or systems of the vehicle 1600 in response to sensor data received from one or more sensors (e.g., sensor inputs). The sensor data may be received from, for example and without limitation, global navigation satellite systems (“GNSS”) sensor(s) 1658 (e.g., Global Positioning System sensor(s)), RADAR sensor(s) 1660, ultrasonic sensor(s) 1662, LIDAR sensor(s) 1664, inertial measurement unit (IMU) sensor(s) 1666 (e.g., accelerometer(s), gyroscope(s), magnetic compass(es), magnetometer(s), etc.), microphone(s) 1696, stereo camera(s) 1668, wide-view camera(s) 1670 (e.g., fisheye cameras), infrared camera(s) 1672, surround camera(s) 1674 (e.g., 360 degree cameras), long-range and/or mid-range camera(s) 1698, speed sensor(s) 1644 (e.g., for measuring the speed of the vehicle 1600), vibration sensor(s) 1642, steering sensor(s) 1640, brake sensor(s) (e.g., as part of the brake sensor system 1646), and/or other sensor types.

One or more of the controller(s) 1636 may receive inputs (e.g., represented by input data) from an instrument cluster 1632 of the vehicle 1600 and provide outputs (e.g., represented by output data, display data, etc.) via a human-machine interface (HMI) display 1634, an audible annunciator, a loudspeaker, and/or via other components of the vehicle 1600. The outputs may include information such as vehicle velocity, speed, time, map data (e.g., the High Definition (“HD”) map 1622 of FIG. 16C), location data (e.g., the vehicle's 1600 location, such as on a map), direction, location of other vehicles (e.g., an occupancy grid), information about objects and status of objects as perceived by the controller(s) 1636, etc. For example, the HMI display 1634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1600 further includes a network interface 1624 which may use one or more wireless antenna(s) 1626 and/or modem(s) to communicate over one or more networks. For example, the network interface 1624 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1626 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 16B is an example of camera locations and fields of view for the example autonomous vehicle 1600 of FIG. 16A, in accordance with some embodiments of the present disclosure. The cameras and respective fields of view are one example embodiment and are not intended to be limiting. For example, additional and/or alternative cameras may be included and/or the cameras may be located at different locations on the vehicle 1600.

The camera types for the cameras may include, but are not limited to, digital cameras that may be adapted for use with the components and/or systems of the vehicle 1600. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1600 (e.g., front-facing cameras) may be used for surround view, to help identify forward facing paths and obstacles, as well aid in, with the help of one or more controllers 1636 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1670 that may be used to perceive objects coming into view from the periphery (e.g., pedestrians, crossing traffic or bicycles). Although only one wide-view camera is illustrated in FIG. 16B, there may be any number (including zero) of wide-view cameras 1670 on the vehicle 1600. In addition, any number of long-range camera(s) 1698 (e.g., a long-view stereo camera pair) may be used for depth-based object detection, especially for objects for which a neural network has not yet been trained. The long-range camera(s) 1698 may also be used for object detection and classification, as well as basic object tracking.

Any number of stereo cameras 1668 may also be included in a front-facing configuration. In at least one embodiment, one or more of stereo camera(s) 1668 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1668 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1668 may be used in addition to, or alternatively from, those described herein.

Cameras with a field of view that include portions of the environment to the side of the vehicle 1600 (e.g., side-view cameras) may be used for surround view, providing information used to create and update the occupancy grid, as well as to generate side impact collision warnings. For example, surround camera(s) 1674 (e.g., four surround cameras 1674 as illustrated in FIG. 16B) may be positioned to on the vehicle 1600. The surround camera(s) 1674 may include wide-view camera(s) 1670, fisheye camera(s), 360 degree camera(s), and/or the like. Four example, four fisheye cameras may be positioned on the vehicle's front, rear, and sides. In an alternative arrangement, the vehicle may use three surround camera(s) 1674 (e.g., left, right, and rear), and may leverage one or more other camera(s) (e.g., a forward-facing camera) as a fourth surround view camera.

Cameras with a field of view that include portions of the environment to the rear of the vehicle 1600 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1698, stereo camera(s) 1668), infrared camera(s) 1672, etc.), as described herein.

FIG. 16C is a block diagram of an example system architecture for the example autonomous vehicle 1600 of FIG. 16A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1600 in FIG. 16C are illustrated as being connected via bus 1602. The bus 1602 may include a Controller Area Network (CAN) data interface (alternatively referred to herein as a “CAN bus”). A CAN may be a network inside the vehicle 1600 used to aid in control of various features and functionality of the vehicle 1600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1602 is described herein as being a CAN bus, this is not intended to be limiting. For example, in addition to, or alternatively from, the CAN bus, FlexRay and/or Ethernet may be used. Additionally, although a single line is used to represent the bus 1602, this is not intended to be limiting. For example, there may be any number of busses 1602, which may include one or more CAN busses, one or more FlexRay busses, one or more Ethernet busses, and/or one or more other types of busses using a different protocol. In some examples, two or more busses 1602 may be used to perform different functions, and/or may be used for redundancy. For example, a first bus 1602 may be used for collision avoidance functionality and a second bus 1602 may be used for actuation control. In any example, each bus 1602 may communicate with any of the components of the vehicle 1600, and two or more busses 1602 may communicate with the same components. In some examples, each SoC 1604, each controller 1636, and/or each computer within the vehicle may have access to the same input data (e.g., inputs from sensors of the vehicle 1600), and may be connected to a common bus, such the CAN bus.

The vehicle 1600 may include one or more controller(s) 1636, such as those described herein with respect to FIG. 16A. The controller(s) 1636 may be used for a variety of functions. The controller(s) 1636 may be coupled to any of the various other components and systems of the vehicle 1600, and may be used for control of the vehicle 1600, artificial intelligence of the vehicle 1600, infotainment for the vehicle 1600, and/or the like.

The vehicle 1600 may include a system(s) on a chip (SoC) 1604. The SoC 1604 may include CPU(s) 1606, GPU(s) 1608, processor(s) 1610, cache(s) 1612, accelerator(s) 1614, data store(s) 1616, and/or other components and features not illustrated. The SoC(s) 1604 may be used to control the vehicle 1600 in a variety of platforms and systems. For example, the SoC(s) 1604 may be combined in a system (e.g., the system of the vehicle 1600) with an HD map 1622 which may obtain map refreshes and/or updates via a network interface 1624 from one or more servers (e.g., server(s) 1678 of FIG. 16D).

The CPU(s) 1606 may include a CPU cluster or CPU complex (alternatively referred to herein as a “CCPLEX”). The CPU(s) 1606 may include multiple cores and/or L2 caches. For example, in some embodiments, the CPU(s) 1606 may include eight cores in a coherent multi-processor configuration. In some embodiments, the CPU(s) 1606 may include four dual-core clusters where each cluster has a dedicated L2 cache (e.g., a 2 MB L2 cache). The CPU(s) 1606 (e.g., the CCPLEX) may be configured to support simultaneous cluster operation enabling any combination of the clusters of the CPU(s) 1606 to be active at any given time.

The CPU(s) 1606 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1606 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1608 may include an integrated GPU (alternatively referred to herein as an “iGPU”). The GPU(s) 1608 may be programmable and may be efficient for parallel workloads. The GPU(s) 1608, in some examples, may use an enhanced tensor instruction set. The GPU(s) 1608 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1608 may include at least eight streaming microprocessors. The GPU(s) 1608 may use compute application programming interface(s) (API(s)). In addition, the GPU(s) 1608 may use one or more parallel computing platforms and/or programming models (e.g., NVIDIA's CUDA).

The GPU(s) 1608 may be power-optimized for best performance in automotive and embedded use cases. For example, the GPU(s) 1608 may be fabricated on a Fin field-effect transistor (FinFET). However, this is not intended to be limiting and the GPU(s) 1608 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1608 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1608 to access the CPU(s) 1606 page tables directly. In such examples, when the GPU(s) 1608 memory management unit (MMU) experiences a miss, an address translation request may be transmitted to the CPU(s) 1606. In response, the CPU(s) 1606 may look in its page tables for the virtual-to-physical mapping for the address and transmits the translation back to the GPU(s) 1608. As such, unified memory technology may allow a single unified virtual address space for memory of both the CPU(s) 1606 and the GPU(s) 1608, thereby simplifying the GPU(s) 1608 programming and porting of applications to the GPU(s) 1608.

In addition, the GPU(s) 1608 may include an access counter that may keep track of the frequency of access of the GPU(s) 1608 to memory of other processors. The access counter may help ensure that memory pages are moved to the physical memory of the processor that is accessing the pages most frequently.

The SoC(s) 1604 may include any number of cache(s) 1612, including those described herein. For example, the cache(s) 1612 may include an L3 cache that is available to both the CPU(s) 1606 and the GPU(s) 1608 (e.g., that is connected both the CPU(s) 1606 and the GPU(s) 1608). The cache(s) 1612 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1604 may include an arithmetic logic unit(s) (ALU(s)) which may be leveraged in performing processing with respect to any of the variety of tasks or operations of the vehicle 1600—such as processing DNNs. In addition, the SoC(s) 1604 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1606 and/or GPU(s) 1608.

The SoC(s) 1604 may include one or more accelerators 1614 (e.g., hardware accelerators, software accelerators, or a combination thereof). For example, the SoC(s) 1604 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1608 and to off-load some of the tasks of the GPU(s) 1608 (e.g., to free up more cycles of the GPU(s) 1608 for performing other tasks). As an example, the accelerator(s) 1614 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1614 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1608, and by using an inference accelerator, for example, a designer may target either the DLA(s) or the GPU(s) 1608 for any function. For example, the designer may focus processing of CNNs and floating point operations on the DLA(s) and leave other functions to the GPU(s) 1608 and/or other accelerator(s) 1614.

The accelerator(s) 1614 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1606. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1614 (e.g., the hardware acceleration cluster) may include a computer vision network on-chip and SRAM, for providing a high-bandwidth, low latency SRAM for the accelerator(s) 1614. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1604 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1614 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1666 output that correlates with the vehicle 1600 orientation, distance, 3D location estimates of the object obtained from the neural network and/or other sensors (e.g., LIDAR sensor(s) 1664 or RADAR sensor(s) 1660), among others.

The SoC(s) 1604 may include data store(s) 1616 (e.g., memory). The data store(s) 1616 may be on-chip memory of the SoC(s) 1604, which may store neural networks to be executed on the GPU and/or the DLA. In some examples, the data store(s) 1616 may be large enough in capacity to store multiple instances of neural networks for redundancy and safety. The data store(s) 1612 may comprise L2 or L3 cache(s) 1612. Reference to the data store(s) 1616 may include reference to the memory associated with the PVA, DLA, and/or other accelerator(s) 1614, as described herein.

The SoC(s) 1604 may include one or more processor(s) 1610 (e.g., embedded processors). The processor(s) 1610 may include a boot and power management processor that may be a dedicated processor and subsystem to handle boot power and management functions and related security enforcement. The boot and power management processor may be a part of the SoC(s) 1604 boot sequence and may provide runtime power management services. The boot power and management processor may provide clock and voltage programming, assistance in system low power state transitions, management of SoC(s) 1604 thermals and temperature sensors, and/or management of the SoC(s) 1604 power states. Each temperature sensor may be implemented as a ring-oscillator whose output frequency is proportional to temperature, and the SoC(s) 1604 may use the ring-oscillators to detect temperatures of the CPU(s) 1606, GPU(s) 1608, and/or accelerator(s) 1614. If temperatures are determined to exceed a threshold, the boot and power management processor may enter a temperature fault routine and put the SoC(s) 1604 into a lower power state and/or put the vehicle 1600 into a chauffeur to safe stop mode (e.g., bring the vehicle 1600 to a safe stop).

The processor(s) 1610 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1610 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1610 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1610 may further include a real-time camera engine that may include a dedicated processor subsystem for handling real-time camera management.

The processor(s) 1610 may further include a high-dynamic range signal processor that may include an image signal processor that is a hardware engine that is part of the camera processing pipeline.

The processor(s) 1610 may include a video image compositor that may be a processing block (e.g., implemented on a microprocessor) that implements video post-processing functions needed by a video playback application to produce the final image for the player window. The video image compositor may perform lens distortion correction on wide-view camera(s) 1670, surround camera(s) 1674, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1608 is not required to continuously render new surfaces. Even when the GPU(s) 1608 is powered on and active doing 3D rendering, the video image compositor may be used to offload the GPU(s) 1608 to improve performance and responsiveness.

The SoC(s) 1604 may further include a mobile industry processor interface (MIPI) camera serial interface for receiving video and input from cameras, a high-speed interface, and/or a video input block that may be used for camera and related pixel input functions. The SoC(s) 1604 may further include an input/output controller(s) that may be controlled by software and may be used for receiving I/O signals that are uncommitted to a specific role.

The SoC(s) 1604 may further include a broad range of peripheral interfaces to enable communication with peripherals, audio codecs, power management, and/or other devices. The SoC(s) 1604 may be used to process data from cameras (e.g., connected over Gigabit Multimedia Serial Link and Ethernet), sensors (e.g., LIDAR sensor(s) 1664, RADAR sensor(s) 1660, etc. that may be connected over Ethernet), data from bus 1602 (e.g., speed of vehicle 1600, steering wheel position, etc.), data from GNSS sensor(s) 1658 (e.g., connected over Ethernet or CAN bus). The SoC(s) 1604 may further include dedicated high-performance mass storage controllers that may include their own DMA engines, and that may be used to free the CPU(s) 1606 from routine data management tasks.

The SoC(s) 1604 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1604 may be faster, more reliable, and even more energy-efficient and space-efficient than conventional systems. For example, the accelerator(s) 1614, when combined with the CPU(s) 1606, the GPU(s) 1608, and the data store(s) 1616, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1620) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1608.

In some examples, a CNN for facial recognition and vehicle owner identification may use data from camera sensors to identify the presence of an authorized driver and/or owner of the vehicle 1600. The always on sensor processing engine may be used to unlock the vehicle when the owner approaches the driver door and turn on the lights, and, in security mode, to disable the vehicle when the owner leaves the vehicle. In this way, the SoC(s) 1604 provide for security against theft and/or carjacking.

In another example, a CNN for emergency vehicle detection and identification may use data from microphones 1696 to detect and identify emergency vehicle sirens. In contrast to conventional systems, that use general classifiers to detect sirens and manually extract features, the SoC(s) 1604 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1658. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1662, until the emergency vehicle(s) passes.

The vehicle may include a CPU(s) 1618 (e.g., discrete CPU(s), or dCPU(s)), that may be coupled to the SoC(s) 1604 via a high-speed interconnect (e.g., PCIe). The CPU(s) 1618 may include an X86 processor, for example. The CPU(s) 1618 may be used to perform any of a variety of functions, including arbitrating potentially inconsistent results between ADAS sensors and the SoC(s) 1604, and/or monitoring the status and health of the controller(s) 1636 and/or infotainment SoC 1630, for example.

The vehicle 1600 may include a GPU(s) 1620 (e.g., discrete GPU(s), or dGPU(s)), that may be coupled to the SoC(s) 1604 via a high-speed interconnect (e.g., NVIDIA's NVLINK). The GPU(s) 1620 may provide additional artificial intelligence functionality, such as by executing redundant and/or different neural networks, and may be used to train and/or update neural networks based on input (e.g., sensor data) from sensors of the vehicle 1600.

The vehicle 1600 may further include the network interface 1624 which may include one or more wireless antennas 1626 (e.g., one or more wireless antennas for different communication protocols, such as a cellular antenna, a Bluetooth antenna, etc.). The network interface 1624 may be used to enable wireless connectivity over the Internet with the cloud (e.g., with the server(s) 1678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1600 information about vehicles in proximity to the vehicle 1600 (e.g., vehicles in front of, on the side of, and/or behind the vehicle 1600). This functionality may be part of a cooperative adaptive cruise control functionality of the vehicle 1600.

The network interface 1624 may include a SoC that provides modulation and demodulation functionality and enables the controller(s) 1636 to communicate over wireless networks. The network interface 1624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1600 may further include data store(s) 1628 which may include off-chip (e.g., off the SoC(s) 1604) storage. The data store(s) 1628 may include one or more storage elements including RAM, SRAM, DRAM, VRAM, Flash, hard disks, and/or other components and/or devices that may store at least one bit of data.

The vehicle 1600 may further include GNSS sensor(s) 1658. The GNSS sensor(s) 1658 (e.g., GPS, assisted GPS sensors, differential GPS (DGPS) sensors, etc.), to assist in mapping, perception, occupancy grid generation, and/or path planning functions. Any number of GNSS sensor(s) 1658 may be used, including, for example and without limitation, a GPS using a USB connector with an Ethernet to Serial (RS-232) bridge.

The vehicle 1600 may further include RADAR sensor(s) 1660. The RADAR sensor(s) 1660 may be used by the vehicle 1600 for long-range vehicle detection, even in darkness and/or severe weather conditions. RADAR functional safety levels may be ASIL B. The RADAR sensor(s) 1660 may use the CAN and/or the bus 1602 (e.g., to transmit data generated by the RADAR sensor(s) 1660) for control and to access object tracking data, with access to Ethernet to access raw data in some examples. A wide variety of RADAR sensor types may be used. For example, and without limitation, the RADAR sensor(s) 1660 may be suitable for front, rear, and side RADAR use. In some example, Pulse Doppler RADAR sensor(s) are used.

The RADAR sensor(s) 1660 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1660 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1600 surroundings at higher speeds with minimal interference from traffic in adjacent lanes. The other two antennae may expand the field of view, making it possible to quickly detect vehicles entering or leaving the vehicle's 1600 lane.

Mid-range RADAR systems may include, as an example, a range of up to 1660 m (front) or 80 m (rear), and a field of view of up to 42 degrees (front) or 1650 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1600 may further include ultrasonic sensor(s) 1662. The ultrasonic sensor(s) 1662, which may be positioned at the front, back, and/or the sides of the vehicle 1600, may be used for park assist and/or to create and update an occupancy grid. A wide variety of ultrasonic sensor(s) 1662 may be used, and different ultrasonic sensor(s) 1662 may be used for different ranges of detection (e.g., 2.5 m, 4 m). The ultrasonic sensor(s) 1662 may operate at functional safety levels of ASIL B.

The vehicle 1600 may include LIDAR sensor(s) 1664. The LIDAR sensor(s) 1664 may be used for object and pedestrian detection, emergency braking, collision avoidance, and/or other functions. The LIDAR sensor(s) 1664 may be functional safety level ASIL B. In some examples, the vehicle 1600 may include multiple LIDAR sensors 1664 (e.g., two, four, six, etc.) that may use Ethernet (e.g., to provide data to a Gigabit Ethernet switch).

In some examples, the LIDAR sensor(s) 1664 may be capable of providing a list of objects and their distances for a 360-degree field of view. Commercially available LIDAR sensor(s) 1664 may have an advertised range of approximately 1600 m, with an accuracy of 2 cm-3 cm, and with support for a 1600 Mbps Ethernet connection, for example. In some examples, one or more non-protruding LIDAR sensors 1664 may be used. In such examples, the LIDAR sensor(s) 1664 may be implemented as a small device that may be embedded into the front, rear, sides, and/or corners of the vehicle 1600. The LIDAR sensor(s) 1664, in such examples, may provide up to a 120-degree horizontal and 35-degree vertical field-of-view, with a 200 m range even for low-reflectivity objects. Front-mounted LIDAR sensor(s) 1664 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1600. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1664 may be less susceptible to motion blur, vibration, and/or shock.

The vehicle may further include IMU sensor(s) 1666. The IMU sensor(s) 1666 may be located at a center of the rear axle of the vehicle 1600, in some examples. The IMU sensor(s) 1666 may include, for example and without limitation, an accelerometer(s), a magnetometer(s), a gyroscope(s), a magnetic compass(es), and/or other sensor types. In some examples, such as in six-axis applications, the IMU sensor(s) 1666 may include accelerometers and gyroscopes, while in nine-axis applications, the IMU sensor(s) 1666 may include accelerometers, gyroscopes, and magnetometers.

In some embodiments, the IMU sensor(s) 1666 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1666 may enable the vehicle 1600 to estimate heading without requiring input from a magnetic sensor by directly observing and correlating the changes in velocity from GPS to the IMU sensor(s) 1666. In some examples, the IMU sensor(s) 1666 and the GNSS sensor(s) 1658 may be combined in a single integrated unit.

The vehicle may include microphone(s) 1696 placed in and/or around the vehicle 1600. The microphone(s) 1696 may be used for emergency vehicle detection and identification, among other things.

The vehicle may further include any number of camera types, including stereo camera(s) 1668, wide-view camera(s) 1670, infrared camera(s) 1672, surround camera(s) 1674, long-range and/or mid-range camera(s) 1698, and/or other camera types. The cameras may be used to capture image data around an entire periphery of the vehicle 1600. The types of cameras used depends on the embodiments and requirements for the vehicle 1600, and any combination of camera types may be used to provide the necessary coverage around the vehicle 1600. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 16A and FIG. 16B.

The vehicle 1600 may further include vibration sensor(s) 1642. The vibration sensor(s) 1642 may measure vibrations of components of the vehicle, such as the axle(s). For example, changes in vibrations may indicate a change in road surfaces. In another example, when two or more vibration sensors 1642 are used, the differences between the vibrations may be used to determine friction or slippage of the road surface (e.g., when the difference in vibration is between a power-driven axle and a freely rotating axle).

The vehicle 1600 may include an ADAS system 1638. The ADAS system 1638 may include a SoC, in some examples. The ADAS system 1638 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1660, LIDAR sensor(s) 1664, and/or a camera(s). The ACC systems may include longitudinal ACC and/or lateral ACC. Longitudinal ACC monitors and controls the distance to the vehicle immediately ahead of the vehicle 1600 and automatically adjust the vehicle speed to maintain a safe distance from vehicles ahead. Lateral ACC performs distance keeping, and advises the vehicle 1600 to change lanes when necessary. Lateral ACC is related to other ADAS applications such as LCA and CWS.

CACC uses information from other vehicles that may be received via the network interface 1624 and/or the wireless antenna(s) 1626 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1600), while the I2V communication concept provides information about traffic further ahead. CACC systems may include either or both I2V and V2V information sources. Given the information of the vehicles ahead of the vehicle 1600, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1660, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1660, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1600 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1600 if the vehicle 1600 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1660, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1600 is backing up. Some RCTW systems include AEB to ensure that the vehicle brakes are applied to avoid a crash. RCTW systems may use one or more rear-facing RADAR sensor(s) 1660, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1600, the vehicle 1600 itself must, in the case of conflicting results, decide whether to heed the result from a primary computer or a secondary computer (e.g., a first controller 1636 or a second controller 1636). For example, in some embodiments, the ADAS system 1638 may be a backup and/or secondary computer for providing perception information to a backup computer rationality module. The backup computer rationality monitor may run a redundant diverse software on hardware components to detect faults in perception and dynamic driving tasks. Outputs from the ADAS system 1638 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1604.

In other examples, ADAS system 1638 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1638 may be fed into the primary computer's perception block and/or the primary computer's dynamic driving task block. For example, if the ADAS system 1638 indicates a forward crash warning due to an object immediately ahead, the perception block may use this information when identifying objects. In other examples, the secondary computer may have its own neural network which is trained and thus reduces the risk of false positives, as described herein.

The vehicle 1600 may further include the infotainment SoC 1630 (e.g., an in-vehicle infotainment system (IVI)). Although illustrated and described as a SoC, the infotainment system may not be a SoC, and may include two or more discrete components. The infotainment SoC 1630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1600. For example, the infotainment SoC 1630 may radios, disk players, navigation systems, video players, USB and Bluetooth connectivity, carputers, in-car entertainment, Wi-Fi, steering wheel audio controls, hands free voice control, a heads-up display (HUD), an HMI display 1634, a telematics device, a control panel (e.g., for controlling and/or interacting with various components, features, and/or systems), and/or other components. The infotainment SoC 1630 may further be used to provide information (e.g., visual and/or audible) to a user(s) of the vehicle, such as information from the ADAS system 1638, autonomous driving information such as planned vehicle maneuvers, trajectories, surrounding environment information (e.g., intersection information, vehicle information, road information, etc.), and/or other information.

The infotainment SoC 1630 may include GPU functionality. The infotainment SoC 1630 may communicate over the bus 1602 (e.g., CAN bus, Ethernet, etc.) with other devices, systems, and/or components of the vehicle 1600. In some examples, the infotainment SoC 1630 may be coupled to a supervisory MCU such that the GPU of the infotainment system may perform some self-driving functions in the event that the primary controller(s) 1636 (e.g., the primary and/or backup computers of the vehicle 1600) fail. In such an example, the infotainment SoC 1630 may put the vehicle 1600 into a chauffeur to safe stop mode, as described herein.

The vehicle 1600 may further include an instrument cluster 1632 (e.g., a digital dash, an electronic instrument cluster, a digital instrument panel, etc.). The instrument cluster 1632 may include a controller and/or supercomputer (e.g., a discrete controller or supercomputer). The instrument cluster 1632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1630 and the instrument cluster 1632. In other words, the instrument cluster 1632 may be included as part of the infotainment SoC 1630, or vice versa.

FIG. 16D is a system diagram for communication between cloud-based server(s) and the example autonomous vehicle 1600 of FIG. 16A, in accordance with some embodiments of the present disclosure. The system 1676 may include server(s) 1678, network(s) 1690, and vehicles, including the vehicle 1600. The server(s) 1678 may include a plurality of GPUs 1684(A)-1684(H) (collectively referred to herein as GPUs 1684), PCIe switches 1682(A)-1682(H) (collectively referred to herein as PCIe switches 1682), and/or CPUs 1680(A)-1680(B) (collectively referred to herein as CPUs 1680). The GPUs 1684, the CPUs 1680, and the PCIe switches may be interconnected with high-speed interconnects such as, for example and without limitation, NVLink interfaces 1688 developed by NVIDIA and/or PCIe connections 1686. In some examples, the GPUs 1684 are connected via NVLink and/or NVSwitch SoC and the GPUs 1684 and the PCIe switches 1682 are connected via PCIe interconnects. Although eight GPUs 1684, two CPUs 1680, and two PCIe switches are illustrated, this is not intended to be limiting. Depending on the embodiment, each of the server(s) 1678 may include any number of GPUs 1684, CPUs 1680, and/or PCIe switches. For example, the server(s) 1678 may each include eight, sixteen, thirty-two, and/or more GPUs 1684.

The server(s) 1678 may receive, over the network(s) 1690 and from the vehicles, image data representative of images showing unexpected or changed road conditions, such as recently commenced road-work. The server(s) 1678 may transmit, over the network(s) 1690 and to the vehicles, neural networks 1692, updated neural networks 1692, and/or map information 1694, including information regarding traffic and road conditions. The updates to the map information 1694 may include updates for the HD map 1622, such as information regarding construction sites, potholes, detours, flooding, and/or other obstructions. In some examples, the neural networks 1692, the updated neural networks 1692, and/or the map information 1694 may have resulted from new training and/or experiences represented in data received from any number of vehicles in the environment, and/or based on training performed at a datacenter (e.g., using the server(s) 1678 and/or other servers).

The server(s) 1678 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1690, and/or the machine learning models may be used by the server(s) 1678 to remotely monitor the vehicles.

In some examples, the server(s) 1678 may receive data from the vehicles and apply the data to up-to-date real-time neural networks for real-time intelligent inferencing. The server(s) 1678 may include deep-learning supercomputers and/or dedicated AI computers powered by GPU(s) 1684, such as a DGX and DGX Station machines developed by NVIDIA. However, in some examples, the server(s) 1678 may include deep learning infrastructure that use only CPU-powered datacenters.

The deep-learning infrastructure of the server(s) 1678 may be capable of fast, real-time inferencing, and may use that capability to evaluate and verify the health of the processors, software, and/or associated hardware in the vehicle 1600. For example, the deep-learning infrastructure may receive periodic updates from the vehicle 1600, such as a sequence of images and/or objects that the vehicle 1600 has located in that sequence of images (e.g., via computer vision and/or other machine learning object classification techniques). The deep-learning infrastructure may run its own neural network to identify the objects and compare them with the objects identified by the vehicle 1600 and, if the results do not match and the infrastructure concludes that the AI in the vehicle 1600 is malfunctioning, the server(s) 1678 may transmit a signal to the vehicle 1600 instructing a fail-safe computer of the vehicle 1600 to assume control, notify the passengers, and complete a safe parking maneuver.

For inferencing, the server(s) 1678 may include the GPU(s) 1684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 17 is a block diagram of an example computing device(s) 1700 suitable for use in implementing some embodiments of the present disclosure. Computing device 1700 may include an interconnect system 1702 that directly or indirectly couples the following devices: memory 1704, one or more central processing units (CPUs) 1706, one or more graphics processing units (GPUs) 1708, a communication interface 1710, input/output (I/O) ports 1712, input/output components 1714, a power supply 1716, one or more presentation components 1718 (e.g., display(s)), and one or more logic units 1720. In at least one embodiment, the computing device(s) 1700 may comprise one or more virtual machines (VMs), and/or any of the components thereof may comprise virtual components (e.g., virtual hardware components). For non-limiting examples, one or more of the GPUs 1708 may comprise one or more vGPUs, one or more of the CPUs 1706 may comprise one or more vCPUs, and/or one or more of the logic units 1720 may comprise one or more virtual logic units. As such, a computing device(s) 1700 may include discrete components (e.g., a full GPU dedicated to the computing device 1700), virtual components (e.g., a portion of a GPU dedicated to the computing device 1700), or a combination thereof.

Although the various blocks of FIG. 17 are shown as connected via the interconnect system 1702 with lines, this is not intended to be limiting and is for clarity only. For example, in some embodiments, a presentation component 1718, such as a display device, may be considered an I/O component 1714 (e.g., if the display is a touch screen). As another example, the CPUs 1706 and/or GPUs 1708 may include memory (e.g., the memory 1704 may be representative of a storage device in addition to the memory of the GPUs 1708, the CPUs 1706, and/or other components). In other words, the computing device of FIG. 17 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 17.

The interconnect system 1702 may represent one or more links or busses, such as an address bus, a data bus, a control bus, or a combination thereof. The interconnect system 1702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1706 may be directly connected to the memory 1704. Further, the CPU 1706 may be directly connected to the GPU 1708. Where there is direct, or point-to-point connection between components, the interconnect system 1702 may include a PCIe link to carry out the connection. In these examples, a PCI bus need not be included in the computing device 1700.

The memory 1704 may include any of a variety of computer-readable media. The computer-readable media may be any available media that may be accessed by the computing device 1700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1706 may be configured to execute at least some of the computer-readable instructions to control one or more components of the computing device 1700 to perform one or more of the methods and/or processes described herein. The CPU(s) 1706 may each include one or more cores (e.g., one, two, four, eight, twenty-eight, seventy-two, etc.) that are capable of handling a multitude of software threads simultaneously. The CPU(s) 1706 may include any type of processor, and may include different types of processors depending on the type of computing device 1700 implemented (e.g., processors with fewer cores for mobile devices and processors with more cores for servers). For example, depending on the type of computing device 1700, the processor may be an Advanced RISC Machines (ARM) processor implemented using Reduced Instruction Set Computing (RISC) or an x86 processor implemented using Complex Instruction Set Computing (CISC). The computing device 1700 may include one or more CPUs 1706 in addition to one or more microprocessors or supplementary co-processors, such as math co-processors.

In addition to or alternatively from the CPU(s) 1706, the GPU(s) 1708 may be configured to execute at least some of the computer-readable instructions to control one or more components of the computing device 1700 to perform one or more of the methods and/or processes described herein. One or more of the GPU(s) 1708 may be an integrated GPU (e.g., with one or more of the CPU(s) 1706 and/or one or more of the GPU(s) 1708 may be a discrete GPU. In embodiments, one or more of the GPU(s) 1708 may be a coprocessor of one or more of the CPU(s) 1706. The GPU(s) 1708 may be used by the computing device 1700 to render graphics (e.g., 3D graphics) or perform general purpose computations. For example, the GPU(s) 1708 may be used for General-Purpose computing on GPUs (GPGPU). The GPU(s) 1708 may include hundreds or thousands of cores that are capable of handling hundreds or thousands of software threads simultaneously. The GPU(s) 1708 may generate pixel data for output images in response to rendering commands (e.g., rendering commands from the CPU(s) 1706 received via a host interface). The GPU(s) 1708 may include graphics memory, such as display memory, for storing pixel data or any other suitable data, such as GPGPU data. The display memory may be included as part of the memory 1704. The GPU(s) 1708 may include two or more GPUs operating in parallel (e.g., via a link). The link may directly connect the GPUs (e.g., using NVLINK) or may connect the GPUs through a switch (e.g., using NVSwitch). When combined together, each GPU 1708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1706 and/or the GPU(s) 1708, the logic unit(s) 1720 may be configured to execute at least some of the computer-readable instructions to control one or more components of the computing device 1700 to perform one or more of the methods and/or processes described herein. In embodiments, the CPU(s) 1706, the GPU(s) 1708, and/or the logic unit(s) 1720 may discretely or jointly perform any combination of the methods, processes and/or portions thereof. One or more of the logic units 1720 may be part of and/or integrated in one or more of the CPU(s) 1706 and/or the GPU(s) 1708 and/or one or more of the logic units 1720 may be discrete components or otherwise external to the CPU(s) 1706 and/or the GPU(s) 1708. In embodiments, one or more of the logic units 1720 may be a coprocessor of one or more of the CPU(s) 1706 and/or one or more of the GPU(s) 1708.

Examples of the logic unit(s) 1720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1710 may include one or more receivers, transmitters, and/or transceivers that enable the computing device 1700 to communicate with other computing devices via an electronic communication network, included wired and/or wireless communications. The communication interface 1710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1720 and/or communication interface 1710 may include one or more data processing units (DPUs) to transmit data received over a network and/or through interconnect system 1702 directly to (e.g., a memory of) one or more GPU(s) 1708.

The I/O ports 1712 may enable the computing device 1700 to be logically coupled to other devices including the I/O components 1714, the presentation component(s) 1718, and/or other components, some of which may be built in to (e.g., integrated in) the computing device 1700. Illustrative I/O components 1714 include a microphone, mouse, keyboard, joystick, game pad, game controller, satellite dish, scanner, printer, wireless device, etc. The I/O components 1714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1700. The computing device 1700 may be include depth cameras, such as stereoscopic camera systems, infrared camera systems, RGB camera systems, touchscreen technology, and combinations of these, for gesture detection and recognition. Additionally, the computing device 1700 may include accelerometers or gyroscopes (e.g., as part of an inertia measurement unit (IMU)) that enable detection of motion. In some examples, the output of the accelerometers or gyroscopes may be used by the computing device 1700 to render immersive augmented reality or virtual reality.

The power supply 1716 may include a hard-wired power supply, a battery power supply, or a combination thereof. The power supply 1716 may provide power to the computing device 1700 to enable the components of the computing device 1700 to operate.

The presentation component(s) 1718 may include a display (e.g., a monitor, a touch screen, a television screen, a heads-up-display (HUD), other display types, or a combination thereof), speakers, and/or other presentation components. The presentation component(s) 1718 may receive data from other components (e.g., the GPU(s) 1708, the CPU(s) 1706, DPUs, etc.), and output the data (e.g., as an image, video, sound, etc.).

### Example Data Center

FIG. 18 illustrates an example data center 1800 that may be used in at least one embodiments of the present disclosure. The data center 1800 may include a data center infrastructure layer 1810, a framework layer 1820, a software layer 1830, and/or an application layer 1840.

As shown in FIG. 18, the data center infrastructure layer 1810 may include a resource orchestrator 1812, grouped computing resources 1814, and node computing resources (“node C.R.s”) 1816(1)-1816(N), where “N” represents any whole, positive integer. In at least one embodiment, node C.R.s 1816(1)-1816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1816(1)-1816(N) may correspond to a server having one or more of the above-mentioned computing resources. In addition, in some embodiments, the node C.R.s 1816(1)-18161(N) may include one or more virtual components, such as vGPUs, vCPUs, and/or the like, and/or one or more of the node C.R.s 1816(1)-1816(N) may correspond to a virtual machine (VM).

In at least one embodiment, grouped computing resources 1814 may include separate groupings of node C.R.s 1816 housed within one or more racks (not shown), or many racks housed in data centers at various geographical locations (also not shown). Separate groupings of node C.R.s 1816 within grouped computing resources 1814 may include grouped compute, network, memory or storage resources that may be configured or allocated to support one or more workloads. In at least one embodiment, several node C.R.s 1816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1812 may configure or otherwise control one or more node C.R.s 1816(1)-1816(N) and/or grouped computing resources 1814. In at least one embodiment, resource orchestrator 1812 may include a software design infrastructure (SDI) management entity for the data center 1800. The resource orchestrator 1812 may include hardware, software, or some combination thereof.

In at least one embodiment, as shown in FIG. 18, framework layer 1820 may include a job scheduler 1833, a configuration manager 1834, a resource manager 1836, and/or a distributed file system 1838. The framework layer 1820 may include a framework to support software 1832 of software layer 1830 and/or one or more application(s) 1842 of application layer 1840. The software 1832 or application(s) 1842 may respectively include web-based service software or applications, such as those provided by Amazon Web Services, Google Cloud and Microsoft Azure. The framework layer 1820 may be, but is not limited to, a type of free and open-source software web application framework such as Apache Spark™ (hereinafter “Spark”) that may utilize distributed file system 1838 for large-scale data processing (e.g., “big data”). In at least one embodiment, job scheduler 1833 may include a Spark driver to facilitate scheduling of workloads supported by various layers of data center 1800. The configuration manager 1834 may be capable of configuring different layers such as software layer 1830 and framework layer 1820 including Spark and distributed file system 1838 for supporting large-scale data processing. The resource manager 1836 may be capable of managing clustered or grouped computing resources mapped to or allocated for support of distributed file system 1838 and job scheduler 1833. In at least one embodiment, clustered or grouped computing resources may include grouped computing resource 1814 at data center infrastructure layer 1810. The resource manager 1836 may coordinate with resource orchestrator 1812 to manage these mapped or allocated computing resources.

In at least one embodiment, software 1832 included in software layer 1830 may include software used by at least portions of node C.R.s 1816(1)-1816(N), grouped computing resources 1814, and/or distributed file system 1838 of framework layer 1820. One or more types of software may include, but are not limited to, Internet web page search software, e-mail virus scan software, database software, and streaming video content software.

In at least one embodiment, application(s) 1842 included in application layer 1840 may include one or more types of applications used by at least portions of node C.R.s 1816(1)-1816(N), grouped computing resources 1814, and/or distributed file system 1838 of framework layer 1820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1834, resource manager 1836, and resource orchestrator 1812 may implement any number and type of self-modifying actions based on any amount and type of data acquired in any technically feasible fashion. Self-modifying actions may relieve a data center operator of data center 1800 from making possibly bad configuration decisions and possibly avoiding underutilized and/or poor performing portions of a data center.

The data center 1800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1800. In at least one embodiment, trained or deployed machine learning models corresponding to one or more neural networks may be used to infer or predict information using resources described above with respect to the data center 1800 by using weight parameters calculated through one or more training techniques, such as but not limited to those described herein.

In at least one embodiment, the data center 1800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1700 of FIG. 17—e.g., each device may include similar components, features, and/or functionality of the computing device(s) 1700. In addition, where backend devices (e.g., servers, NAS, etc.) are implemented, the backend devices may be included as part of a data center 1800, an example of which is described in more detail herein with respect to FIG. 18.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1700 described herein with respect to FIG. 17. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: obtaining a map indicating that one or more voxels associated with an environment are associated with a first state, the first state of the one or more voxels being based at least on first sensor data associated with a first period of time; obtaining second sensor data generated using one or more machines navigating within the environment, the second sensor data associated with a second period of time subsequent the first period of time; projecting, based at least on the second sensor data, one or more rays associated with the environment; determining, based at least on the one or more rays, that the one or more voxels are associated with a second state different from the first state; and causing the map to indicate that the one or more voxels are associated with the second state.

B: The method of paragraph A, wherein: the first state comprises at least one of an occupied state, an unoccupied state, or an unknown state; and the second state comprises at least one of the occupied state, the unoccupied state, or the unknown state.

C: The method of either paragraph A or paragraph B, wherein the determining that the one or more voxels are associated with the second state comprises: determining that the map indicates that the one or more voxels are associated with an occupied state, the first state including the occupied state; determining that the one or more rays pass through the one or more voxels; and determining that the one or more voxels are in an unoccupied state based at least on the one or more rays passing through the one or more voxels, the second state including the unoccupied state.

D: The method of any one of paragraphs A-C, wherein the determining that the one or more voxels are associated with the second state comprises: determining that the map indicates that the one or more voxels are associated with an unoccupied state, the first state including the unoccupied state; determining that one or more points associated with the one or more rays are located within the one or more voxels; and determining that the one or more voxels are in an occupied state based at least on the one or more points being located within the one or more voxels, the second state including the occupied state.

E: The method of any one of paragraphs A-D, wherein the determining that the one or more voxels are associated with the second state comprises: determining that the map indicates that the one or more voxels are associated with an unknown state, the first state including the unknown state; determining that the one or more rays at least one of contact the one or more voxels or pass through the one or more voxels; and determining that the one or more voxels are in the second state based at least on the one or more rays at least one of contacting the one or more voxels or passing through the one or more voxels.

F: The method of any one of paragraphs A-E, further comprising: determining that an event occurred that causes the second sensor data to include an updated version as compared to the first sensor data, the event including at least one of: the second period of time being a threshold period of time after the first period of time; or one or more updates occurring with regard to the environment, wherein the causing the map associated with the environment to indicate that the one or more voxels are associated with the second state is based at least on the second sensor data including the updated version as compared to the first sensor data.

G: The method of any one of paragraphs A-F, wherein: the first sensor data is associated with one or more first poses within the environment; and the method further localizing, based at least on the one or more first poses, the second sensor data with respect to one or more second poses within the environment.

H: A system comprising: one or more processors to: obtain a map that indicates that one or more portions of an environment are associated with a first state, the first state of the one or more portions being based at least on first data associated with a first period of time; obtain second data representative of the environment, the second data associated with a second period of time subsequent the first period of time; determining, based at least on the second data, the one or more portions of the environment are associated with at least one of the first state or a second state; and based at least on the second data being associated with the second period of time that is after the first period of time, cause the map to indicate that the one or more portions of the environment are associated with the at least one of the first state or the second state.

I: The system of paragraph H, wherein: the determination that the one or more portions are associated with the at least one of the first state or the second state comprises determining, based at least on the second data, that the one or more portions are also associated with the first state; and the map being caused to indicate that the one or more portions are associated with the at least one of the first state or the second state comprises refraining from updating a portion of the map that is associated with the one or more portions of the environment.

J: The system of either paragraph H or paragraph I, wherein: the determination that the one or more portions are associated with the at least one of the first state or the second state comprises determining, based at least on the second data, that the one or more portions are associated with the second state; and the map being caused to indicate that the one or more portions are associated with the at least one of the first state or the second state comprises updating the map to indicate that the one or more portions are associated with the second state instead of the second state.

K: The system of any one of paragraphs H-J wherein the one or more processors are further to determine the one or more portions of the environment as including one or more voxels located within the environment.

L: The system of any one of paragraphs H-K, wherein the determination that the one or more portions of the environment are associated with the at least one of the first state or the second state comprises: projecting, based at least on the second data, one or more rays within the environment; determining whether the one or more rays intersect with the one or more portions of the environment; and determining, based at least on whether the one or more rays intersect the one or more portions of the environment, that the one or more portions of the environment are associated with the at least one of the first state or the second state.

M: The system of paragraph L, wherein the determination that the one or more portions are associated with at least one of the first state or the second state comprises: determining that the map indicates that the one or more portions are associated with an occupied state, the first state including the occupied state; determining that the one or more rays pass through the one or more portions; and determining that the one or more portions are in an unoccupied state based at least on the one or more rays passing through the one or more portions, the second state including the unoccupied state.

N: The system of paragraph L, wherein the determination that the one or more portions are associated with at least one of the first state or the second state comprises: determining that the map indicates that the one or more portions are associated with an unoccupied state, the first state including the unoccupied state; determining that one or more points associated with the one or more rays are located within the one or more portions; and determining that the one or more portions are in an occupied state based at least on the one or more points being located within the one or more portions, the second state including the occupied state.

O: The system of paragraph L, wherein the determination that the one or more portions are associated with at least one of the first state or the second state comprises: determining that the map indicates that the one or more portions are associated with an unknown state, the first state including the unknown state; determining that the one or more rays at least one of contact the one or more portions or pass through the one or more portions; and determining that the one or more portions are in the second state based at least on the one or more rays at least one of contacting the one or more portions or passing through the one or more portions.

P: The system of any one of paragraphs H-O, wherein the one or more processors are further to: determine that an event occurred that causes the second data to include an updated version as compared to the first data, the event including at least one of: the second period of time being a threshold period of time after the first period of time; or one or more updates occurring with regard to the environment, wherein the causation of the map associated with the environment to indicate that the one or more portions of the environment are associated with the at least one of the first state or the second state is based at least on the second data including the updated version as compared to the first data.

Q: The system of paragraph P, wherein the one or more processors are further to: store third data that associates the first data with a first version; and based at least on the event occurring, store fourth data that associates the second data with a second version, the second version including the updated version as compared to the first version.

R: The system of any one of paragraphs H-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to update a map associated with an environment to indicate that one or more voxels associated with the environment are associated with an updated state, wherein the map is updated based at least on first sensor data associated with a first period of time indicating that the one or more voxels are associated with a prior state and second sensor data associated with a second period of time indicating that the one or more voxels are associated with the updated state.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

U: A method comprising: obtaining a pose graph associated with an environment, the pose graph indicating one or more poses associated with first sensor data representative of the environment during a first period of time; obtaining second sensor data representative of the environment during a second period of time; projecting, based at least on the second sensor data, one or more rays associated with the environment; determining, based at least on the one or more rays, an amount of coverage for at least a pose of the one or more poses; determining that the amount of coverage is equal to or greater than a threshold amount of coverage; and based at least on the amount of coverage being equal to or greater than the threshold amount of coverage, updating the pose graph by removing at least the pose from the one or more poses.

V: The method of paragraph U, further comprising: determining, based at least on the second sensor data, a second amount of coverage for at least a second pose of the one or more poses; determining that the second amount of coverage is less than the threshold amount of coverage; and based at least on the second amount of coverage being less than the threshold amount of coverage, causing the pose map to continue indicating the second pose.

W: The method of either paragraph U or paragraph V, wherein the determining the amount of coverage comprises: determining, based at least on at least a portion of the first sensor data that is associated with the pose, one or more voxels located within the environment; determining a number of voxels from the one or more voxels for which the one or more rays intersect; and determining the amount of coverage based at least on the number of voxels.

X: The method of paragraph W, further comprising: determining a total number of voxels associated with the one or more voxels, wherein the determining the amount of coverage is based at least on dividing the number of voxels that the one or more rays intersect with the total number of voxels.

Y: The method of any one of paragraphs U-X, further comprising: determining that the second sensor data is associated with one or more second poses within the environment; and determining that the one or more second poses are related to the pose, wherein the determining the amount of coverage is further based at least on the one or more second poses being related to the pose.

Z: The method of any one of paragraphs U-Y, further comprising: determining that the second sensor data is associated with one or more second poses within the environment; and updating the pose map to further indicate the one or more second poses associated with the second sensor data.

AA: A system comprising: one or more processors to: obtain a pose graph associated with an environment, the pose graph indicating one or more poses associated with first sensor data representative of the environment; determine, based at least on second sensor data representative of the environment, an amount of coverage for at least a pose of the one or more poses; determine whether the amount of coverage is equal to or greater than a threshold amount of coverage; and determine whether to update the pose graph based at least on whether the amount of coverage is equal to or greater than the threshold amount of coverage.

AB: The system of paragraph AA, wherein the determination of whether to update the pose graph comprises one of: determining, based at least on the amount of coverage being equal to or greater than the threshold amount of coverage, to update the pose graph by removing the pose; or determining, based at least on the amount of coverage being less than the threshold amount of coverage, to refrain from updating the pose graph.

AC: The system of either paragraph AA or paragraph AB, wherein the determination of the amount of coverage comprises: determining, based at least on at least a portion of the first sensor data that is associated with the pose, one or more portions of within the environment; projecting, based at least on the second sensor data, one or more rays within the environment; determining a number of portions from the one or more portions for which the one or more rays intersect; and determining the amount of coverage based at least on the number of portions.

AD: The system of paragraph AC, wherein the one or more processors are further to: determine a total number of portions associated with the one or more portions, wherein the determination of the amount of coverage is further based at least on the total number of portions.

AE: The system of paragraph AC, wherein the one or more processors are further to: determine a second number of portions that are obstructed from the one or more portions; and wherein the determination of the amount of coverage is further based at least on the second number of portions.

AF: The system of paragraph AC, wherein the one or more processors are further to: determine that a second portion of the first sensor data is associated with one or more dynamic objects located within the environment; and determining the portion of the first sensor data by at least removing the second portion of the first sensor data based at least on the second portion of the first sensor data being associated with the one or more dynamic objects.

AG: The system of any one of paragraphs AA-AF, wherein the one or more processors are further to: determine that the second sensor data is associated with one or more second poses within the environment; and determine that the one or more second poses are related to the pose, wherein the determination of the amount of coverage is further based at least on the one or more second poses being related to the pose.

AH: The system of any one of paragraphs AA-AG, wherein the one or more processors are further to: determine that the second sensor data is associated with one or more second poses within the environment; and update the pose graph to further indicate the one or more second poses associated with the second sensor data.

AI: The system of paragraph AH, wherein the one or more processors are further to: determine one or more edges indicating one or more connections between the one or more second poses and the one or more first poses; and update the pose graph to indicate the one or more edges.

AJ: The system of paragraph AH, wherein the one or more processors are further to: determine a number of edges between at least a second pose of the one or more poses and a third pose of the one or more second poses; determine a distance between the second pose and the third pose within the environment; determine, based at least on the number of edges and the distance, to add an edge connecting the second pose to the third pose; and update the pose graph to indicate the edge connecting the second pose to the third pose.

AK: The system of any one of paragraphs AA-AJ, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

AL: One or more processors comprising: processing circuitry to cause a pose graph to be updated by at least removing a pose from one or more poses associated with first sensor data representative of an environment, wherein the pose graph is updated based at least on an amount of coverage associated with the pose that is determined using at least a portion of the first sensor data and second sensor data representative of the environment.

AM: The one or more processors of paragraph AL, wherein the processing circuitry is further to: determine, based at least on the at least the portion of the first sensor data, one or more voxels located within the environment; project, based at least on the second sensor data, one or more rays within the environment; determine a number of voxels from the one or more voxels for which the one or more rays intersect; and determine the amount of coverage based at least on the number of voxels.

AN: The one or more processors of either paragraph AL or paragraph AM wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
obtaining a pose graph associated with an environment, the pose graph indicating one or more poses associated with first sensor data representative of the environment during a first period of time;
obtaining second sensor data representative of the environment during a second period of time;
projecting, based at least on the second sensor data, one or more rays associated with the environment;
determining, based at least on the one or more rays, an amount of coverage for at least a pose of the one or more poses;
determining that the amount of coverage is equal to or greater than a threshold amount of coverage; and
based at least on the amount of coverage being equal to or greater than the threshold amount of coverage, updating the pose graph by removing at least the pose from the one or more poses.

2. The method of claim 1, further comprising:
determining, based at least on the second sensor data, a second amount of coverage for at least a second pose of the one or more poses;
determining that the second amount of coverage is less than the threshold amount of coverage; and
based at least on the second amount of coverage being less than the threshold amount of coverage, causing the pose map to continue indicating the second pose.

3. The method of claim 1, wherein the determining the amount of coverage comprises:
determining, based at least on at least a portion of the first sensor data that is associated with the pose, one or more voxels located within the environment;
determining a number of voxels from the one or more voxels for which the one or more rays intersect; and
determining the amount of coverage based at least on the number of voxels.

4. The method of claim 3, further comprising:
determining a total number of voxels associated with the one or more voxels,
wherein the determining the amount of coverage is based at least on dividing the number of voxels that the one or more rays intersect with the total number of voxels.

5. The method of claim 1, further comprising:
determining that the second sensor data is associated with one or more second poses within the environment; and
determining that the one or more second poses are related to the pose,
wherein the determining the amount of coverage is further based at least on the one or more second poses being related to the pose.

6. The method of claim 1, further comprising:
determining that the second sensor data is associated with one or more second poses within the environment; and
updating the pose map to further indicate the one or more second poses associated with the second sensor data.

7. A system comprising:
one or more processors to:
obtain a pose graph associated with an environment, the pose graph indicating one or more poses associated with first sensor data representative of the environment;
determine, based at least on second sensor data representative of the environment, an amount of coverage for at least a pose of the one or more poses;
determine whether the amount of coverage is equal to or greater than a threshold amount of coverage; and
determine whether to update the pose graph based at least on whether the amount of coverage is equal to or greater than the threshold amount of coverage.

8. The system of claim 7, wherein the determination of whether to update the pose graph comprises one of:
determining, based at least on the amount of coverage being equal to or greater than the threshold amount of coverage, to update the pose graph by removing the pose; or
determining, based at least on the amount of coverage being less than the threshold amount of coverage, to refrain from updating the pose graph.

9. The system of claim 7, wherein the determination of the amount of coverage comprises:
determining, based at least on at least a portion of the first sensor data that is associated with the pose, one or more portions of within the environment;
projecting, based at least on the second sensor data, one or more rays within the environment;
determining a number of portions from the one or more portions for which the one or more rays intersect; and
determining the amount of coverage based at least on the number of portions.

10. The system of claim 9, wherein the one or more processors are further to:
determine a total number of portions associated with the one or more portions,
wherein the determination of the amount of coverage is further based at least on the total number of portions.

11. The system of claim 9, wherein the one or more processors are further to:
determine a second number of portions that are obstructed from the one or more portions; and
wherein the determination of the amount of coverage is further based at least on the second number of portions.

12. The system of claim 9, wherein the one or more processors are further to:
determine that a second portion of the first sensor data is associated with one or more dynamic objects located within the environment; and
determining the portion of the first sensor data by at least removing the second portion of the first sensor data based at least on the second portion of the first sensor data being associated with the one or more dynamic objects.

13. The system of claim 7, wherein the one or more processors are further to:
determine that the second sensor data is associated with one or more second poses within the environment; and
determine that the one or more second poses are related to the pose,
wherein the determination of the amount of coverage is further based at least on the one or more second poses being related to the pose.

14. The system of claim 7, wherein the one or more processors are further to:
determine that the second sensor data is associated with one or more second poses within the environment; and
update the pose graph to further indicate the one or more second poses associated with the second sensor data.

15. The system of claim 14, wherein the one or more processors are further to:
determine one or more edges indicating one or more connections between the one or more second poses and the one or more first poses; and
update the pose graph to indicate the one or more edges.

16. The system of claim 14, wherein the one or more processors are further to:
determine a number of edges between at least a second pose of the one or more poses and a third pose of the one or more second poses;
determine a distance between the second pose and the third pose within the environment;
determine, based at least on the number of edges and the distance, to add an edge connecting the second pose to the third pose; and
update the pose graph to indicate the edge connecting the second pose to the third pose.

17. The system of claim 7, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more processors comprising:
processing circuitry to cause a pose graph to be updated by at least removing a pose from one or more poses associated with first sensor data representative of an environment, wherein the pose graph is updated based at least on an amount of coverage associated with the pose that is determined using at least a portion of the first sensor data and second sensor data representative of the environment.

19. The one or more processors of claim 18, wherein the processing circuitry is further to:
determine, based at least on the at least the portion of the first sensor data, one or more voxels located within the environment;
project, based at least on the second sensor data, one or more rays within the environment;
determine a number of voxels from the one or more voxels for which the one or more rays intersect; and
determine the amount of coverage based at least on the number of voxels.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
